(19) United States
(12) Patent Application Publication
(10) Pub. No.: US 2026/0227229 A1
(43) Pub. Date: Aug. 6, 2026

(54) ONBOARD WEIGHT AND BALANCE DETECTION SYSTEM FOR AN AIRCRAFT

(71) Applicant: THE BOEING COMPANY, Arlington, VA (US)

(72) Inventor: Michael A. Long, Hilo, HI (US)

(21) Appl. No.: 19/043,996

(22) Filed: Feb. 3, 2025

(51) Int. Cl. G01G 19/07; B64C 25/60

(52) U.S. Cl. CPC G01G 19/07; B64C 25/60

(57) ABSTRACT

A method includes obtaining pressure data and temperature data for gas in shock struts of a plurality of landing gear of an aircraft. The method includes obtaining load data for each landing gear from one or more load sensors associated with the landing gear. The method includes determining a gross weight, a center of gravity, or both, of the aircraft based on a pitch of the aircraft, the pressure data, the temperature data, the load data, model parameters, or combinations thereof. The method includes accumulating pressure data, temperature data, load data, and the pitch of the aircraft as calibration data for transitions of shock struts from dynamic states to static states. The method includes obtaining updated model parameters based on the calibration data. The method also includes replacing one or more of the model parameters with corresponding updated model parameters in response to satisfaction of a threshold.

### FIELD OF THE DISCLOSURE

The present disclosure is generally related to an onboard weight and balance detection system for an aircraft.

### BACKGROUND

A weight of an aircraft and balance of the aircraft are factors affecting aircraft safety. An aircraft that weighs more than an acceptable gross weight, that is unbalanced (e.g., an aircraft with a center of gravity (CG) outside of allowable limits), or both, can be both inefficient and unsafe. Weight and balance of the aircraft influence many factors associated with a flight of the aircraft including fuel needed for the flight, runway lengths needed for takeoff and landing, horizontal stabilizer settings, handling characteristics, operating and performance parameters, etc. Weight scales may be used to determine the weight and the balance of the aircraft. Having weight scales at each location where aircraft are loaded and unloaded is impractical due to expense, increased turnaround time, maintenance needed for the weight scales, and other factors. It is desirable for an aircraft (e.g., a passenger aircraft or a cargo aircraft that includes a landing gear system with pneumatic shock struts) to include an onboard weight and balance system that enables a computer system of the aircraft to determine the weight and balance of the aircraft based on sensor data obtained from sensors coupled to the aircraft and enables periodic updating of parameters used to determine the weight and balance based on self-calibration to accommodate changes that occur over time.

### SUMMARY

In a particular implementation, an aircraft includes a plurality of landing gear. Each landing gear of the plurality of landing gear includes a shock strut. The aircraft includes one or more attitude sensors to output a pitch of the aircraft. The aircraft includes a plurality of sensors associated with each landing gear. The plurality of sensors includes a pressure sensor configured to generate pressure data indicative of a gas pressure in the shock strut, a temperature sensor configured to generate temperature data indicative of a gas temperature in the shock strut, and one or more load sensors to generate load data indicative of a load on the landing gear. The aircraft also includes a computer system. The computer system includes an onboard weight and balance system. The computer system is configured to determine a gross weight, center of gravity (CG), or both, of the aircraft based on output of the one or more attitude sensors, output of the plurality of sensors, and model parameters. The computer system is configured to accumulate selected pressure data, selected temperature data, selected load data, and the pitch of the aircraft as calibration data for transitions of shock struts from dynamic states to static states. The computer system is configured to obtain one or more updated model parameters based on the calibration data. The computer system is also configured to replace one or more of the model parameters with corresponding updated model parameters in response to satisfaction of a threshold.

In another particular implementation, a method includes obtaining, at a computer system of an aircraft during loading and unloading of the aircraft, pressure data and temperature data for gas in respective ones of shock struts of a plurality of landing gear of the aircraft. The method includes obtaining, at the computer system, load data for each landing gear of the plurality of landing gear from one or more load sensors associated with the landing gear. The method includes determining, at the computer system, a gross weight, CG, or both, of the aircraft based on a pitch of the aircraft from output of one or more attitude sensors, the pressure data, the temperature data, the load data, model parameters, or combinations thereof. The method includes accumulating, at the computer system, selected pressure data, selected temperature data, selected load data, and the pitch of the aircraft as calibration data for transitions of shock struts from dynamic states to static states. The method includes obtaining, at the computer system, updated model parameters based on the calibration data. The method also includes replacing, via the computer system, one or more of the model parameters with corresponding updated model parameters in response to satisfaction of a threshold.

In another particular implementation, a non-transitory, computer-readable medium including instructions that, when executed by one or more processors associated with an onboard weight and balance system of an aircraft, cause the one or more processors to obtain, during loading and unloading of the aircraft, pressure data and temperature data for gas in respective ones of shock struts of a plurality of landing gear of the aircraft. The instructions are executable by the one or more processors to obtain, during the loading and the unloading of the aircraft, load data for each landing gear of the plurality of landing gear from one or more load sensors associated with the landing gear. The instructions are executable by the one or more processors to determine a gross weight, CG, or both, of the aircraft based on a pitch of the aircraft from output of one or more attitude sensors, the pressure data, the temperature data, the load data, model parameters, or combinations thereof. The instructions are executable by the one or more processors to accumulate selected pressure data, selected temperature data, selected load data, and the pitch of the aircraft as calibration data for transitions of shock struts from dynamic states to static states. The instructions are executable by the one or more processors to obtain updated parameters for the model parameters based on the calibration data. The instructions are also executable by the one or more processors to replace one or more of the model parameters with corresponding updated model parameters in response to satisfaction of a threshold.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 depicts a block diagram of an aircraft.

FIG. 2 depicts a side view representation of a portion of the aircraft.

FIG. 3 depicts a vertical load on shock strut versus pressure diagram for a shock strut of an aircraft during loading and unloading of the aircraft.

FIG. 4 is a pressure versus time diagram for the shock strut of the aircraft of FIG. 3 for the loading of the aircraft represented in FIG. 3.

FIG. 5 is a flow chart of an implementation of a method of use of a weight and balance system of an aircraft.

FIG. 6 is a flow chart illustrating a life cycle of an aircraft.

FIG. 7 is a block diagram of a computing environment including a computing device configured to support aspects of computer-implemented methods and computer-executable program instructions (or code) according to the present disclosure.

### DETAILED DESCRIPTION

The present disclosure describes onboard weight and balance systems for aircraft. The aircraft transport passengers, cargo, or both, and each aircraft includes a landing gear system having pneumatic shock struts. An onboard weight and balance system of an aircraft utilizes a pitch of the aircraft, temperature data and pressure data associated with gas in shock struts of a plurality of landing gear, and load data from one or more load sensors associated with each of the landing gear to determine the weight of the aircraft and the balance of the aircraft when the aircraft is not in motion and on the ground (e.g., during loading and unloading of the aircraft). The onboard weight and balance system uses models to determine the weight of the aircraft. The onboard weight and balance system self-calibrates model parameters to extend a use time of the weight and balance system to a use life of the aircraft or a time when the aircraft is placed on weight scales to allow for recalibration of the weight and balance system based on output of the weight scales.

The onboard weight and balance system determines a vertical ground load of each landing gear based on output of sensors (e.g., pressure, temperature, load sensor data, and pitch attitude). The onboard weight and balance system determines the weight of the aircraft and the CG of the aircraft from the vertical ground loads. The weight and balance system also provides the weight and CG of the aircraft as output to a load master for the aircraft, to pilot(s) of the aircraft, or both.

Each shock strut of the landing gear system of the aircraft supports a portion of the weight of the aircraft. A shock strut can be modeled as a piston and cylinder system with a gas in a chamber between the piston and a cylinder end, where the piston is able to move relative to the cylinder end based on a load applied to the shock strut. The load is opposed or aided by a first force that the gas in the chamber applies to the piston and a friction force acting between the cylinder and the piston. The first force is equal to an effective surface area of the piston multiplied by the gas pressure in the chamber. The friction force is a dynamic friction force acting in a direction opposite to a direction of travel of the piston when the shock strut is in a dynamic state, and the friction force is a static friction force acting in a direction opposite to the previous direction of travel when the shock strut is in a static state. At a transition between the dynamic state and the static state, the dynamic friction force transitions to the static friction force and the dynamic friction force is the same as the static friction force, which is referred to herein as the friction force.

When the load applied to the shock strut is increased while the shock strut is in the static state, the static friction force resists movement of the piston toward the cylinder end. The static friction force increases as the load increases up to a compression breakout friction force, and the gas pressure of the shock strut does not change during the static state absent any changes due to temperature effects. If the load is further increased when the static friction force is at the compression breakout friction force, the shock strut enters a dynamic state and the piston moves to compress the gas in the chamber due to the load on the shock strut and the pressure of the gas in the chamber increases. If additional load below a maximum load is applied to the shock strut while the shock strut is in the dynamic state in a batchwise manner, or continuously at a rate below a rate that prevents the shock strut from transitioning to a static state, the load increases and a time that the shock strut remains in the dynamic state increases. The piston continues to move until the load is balanced by the first force plus the friction force at the transition from the dynamic state to another static state. At the transition, increasing pressure due to movement of the piston stops. The piston will not move again if the load is changed until another compression breakout friction force is crossed due to application of additional load to the shock strut, or until an expansion breakout friction force is crossed due to reduction of the applied load to the shock strut. Also, a change in the gas pressure due to a change in gas temperature will change the static friction unless the change in gas pressure causes the static friction to cross a compression breakout friction force or an expansion breakout friction force.

When the load applied to the shock strut is reduced while the shock strut is in the static state, the static friction force resists movement of the piston away from the cylinder end. The static friction force becomes less as the load is reduced until the static friction force reaches an expansion breakout friction force, and the gas pressure of the shock strut does not change absent any changes due to temperature effects. If the load is further reduced when the static friction force is at the expansion breakout friction force, the shock strut enters a dynamic state and the piston moves to expand the gas in the chamber due to the load on the shock strut and the pressure of the gas in the chamber decreases. If the load on the shock strut is further reduced while the shock strut is in the dynamic state in a batchwise manner without the piston reaching a maximum extension, or continuously at a rate below a rate that prevents the shock strut from transitioning to a static force before the piston reaches the maximum extension, the load decreases and a time that the shock strut remains in the dynamic state increases. The piston continues to move until the load is balanced by the first force plus the friction force at the transition from the dynamic state to another static state. At the transition, decreasing pressure due to movement of the piston stops. The piston will not move again if the load is changed until a compression breakout friction force is crossed due to application of additional load to the shock strut, or until another expansion breakout friction force is crossed due to further reduction of the applied load to the shock strut. Also, a change in the gas pressure due to a change in gas temperature will change the static friction unless the change in gas pressure causes the static friction to cross a compression breakout friction force or an expansion breakout friction force.

Gas pressure data for the shock strut is analyzed to determine a first time when the shock strut transitions from a first static state to a dynamic state and a second time when the shock strut transitions from the dynamic state to a second static state. During the first static state the gas pressure is at a substantially constant first value. When the shock strut transitions from the first static state to the dynamic state due to crossing of a compression breakout force or an expansion breakout force, the gas pressure data shows rapid pressure change. When the shock strut transitions from the dynamic state to the second static state at the second time, the gas pressure becomes substantially constant. At the transition, which corresponds to the second time, the friction force can be determined using a friction force model, and the load on the shock strut at the second time can be determined as the first force, which is the gas pressure multiplied by an effective surface area of the piston, plus the friction force. The friction force model determines the friction force at a transition from a dynamic state to a static state. The friction force model is a linear model having a slope and a y-intercept. The linear model for a shock strut is a function of gas pressures at the transitions of the shock strut from dynamic states to static states.

The friction force is also a function of gas temperature. For example, the friction force at a particular transition from the dynamic state to the static state at a first pressure when the gas temperature in the shock strut is-30 degrees Celsius (−22 degrees Fahrenheit) would not be the same as the friction force at another transition from the dynamic state to the static state at the first pressure when the gas temperature in the shock strut is 50 degrees Celsius (122 degrees Fahrenheit) due to the effect of temperature on the friction force at the transition, but the temperature dependence has minor effect within a limited temperature range (e.g., plus or minus 1 degree Celsius, plus or minus 3 degrees Celsius, plus or minus 5 degrees Celsius, or some other temperature range). To take into consideration the temperature dependence of the friction force, the model parameters of a plurality of models with different temperature ranges in a working temperature range of the shock strut are determined. A friction force model with a temperature range that includes the gas temperature of the shock strut at the transition is used to determine the friction force of the shock strut, which allows the load on the shock strut to be determined and the vertical force on the landing gear that includes the shock strut.

At the transition from a first dynamic state to a first static state for a shock strut of a landing gear, the onboard weight and balance system determines the load on the shock strut using an appropriate friction force model associated with the gas temperature at the transition based on the gas pressure at the transition. From a first time associated with the transition, through the static state to a second time when a second dynamic state starts, the load on the shock strut is determined as the first load plus a change in the load applied to the shock strut determined as a delta load from output of the one or more load sensors associated with the shock strut. At a second transition from the second dynamic state to the second static state, the onboard weight and balance system determines a second load on the shock strut using a friction force model associated with the gas temperature at the second temperature and based on the gas pressure at the second transition. Further load changes to the shock strut until a subsequent transition to a next dynamic state are determined based on the second load and the delta load determined using the output of the one or more load sensors.

Load variation sensitivity, use environment, repeatability, and other considerations prevent the use of load sensors that are able to provide output of an absolute value of weight applied to the load sensors at a particular time, but the load sensor output of a load sensor provides a useful estimate of a delta load during a time span (e.g., during a static state of a shock strut when the gas pressure in the shock strut is constant). Output of the load sensors are substantially independent of temperature throughout a large temperature range (e.g., from −40 degrees Celsius (−40 degrees Fahrenheit) to 40 degrees Celsius (104 degrees Fahrenheit)). The onboard weight and balance system may be configured to apply manufacturer supplied corrections for the load sensors if the load sensors are operated outside of corresponding operating temperature ranges.

The onboard weight and balance system includes a weight and balance unit that determines the gross weight of the aircraft and the balance of the aircraft based on output of sensors associated with each of the landing gear and a pitch of the aircraft determined from output of one or more attitude sensors. The weight and balance unit determines, for each shock strut associated with a landing gear, a most recent vertical load on the shock strut at a most recent transition of the shock strut from a dynamic state to a static state. Subsequent to the most recent transition to the next transition of the shock strut from a dynamic state to a static state, the weight and balance unit determines the vertical load on the shock strut based on the most recent vertical load on the shock strut at the most recent transition plus the change to vertical load subsequent to the most recent transition based on output of the one or more load sensors associated with the landing gear. The onboard weight and balance system uses the vertical load on each of the shock struts to determine the vertical load of corresponding landing gear on the ground, and uses the vertical ground loads of the landing gear to determine the weight and the balance of the aircraft.

The onboard weight and balance system includes a self-calibration unit to adjust the model parameters of the friction force models associated with the shock struts and to adjust gain parameters of gain models associated with corresponding load sensors to compensate for changes to the onboard weight and balance system that occur over time. The self-calibration unit utilizes calibration data obtained during use of the weight and balance system to determine updated friction force parameters (e.g., slope and y-intercept) for the friction force models and updated gain parameters (e.g., gain) for the load sensors.

The self-calibration unit preferably accumulates calibration data for updating friction force parameters of a shock strut and gain parameters of load sensors associated with a landing gear that includes the shock strut during periods of operation of the shock strut when the motion of an inner cylinder of the shock strut relative to an outer cylinder of the shock strut is slow and steady. Such motion occurs when the aircraft is being fueled or defueled. Defueling of aircraft is rarely performed. In some implementations, the self-calibration unit accumulates selected pressure data, selected temperature data, selected load data, and the pitch of the aircraft as calibration data during fueling of the aircraft, and if defueling occurs, during defueling of the aircraft. The onboard weight and balance system determines that the aircraft is being fueled or defueled based on operator input (e.g., pilot input), analysis of pressure data, or both.

In some implementations, updated friction force parameters associated with loading the aircraft are determined based only on calibration data associated with data accumulated during fueling of the aircraft. In other implementations, calibration data for loading that does not occur when the aircraft is being fueled is also accumulated and used to determine the updated parameters for the friction models associated with the loading of the aircraft, but the friction force parameters determined from calibration data associated with the aircraft during fueling of the aircraft is weighted by a factor (e.g., 2, 3, 5, 10, or some other factor). Because defueling of an aircraft rarely, if ever, occurs, calibration data for determining updated model parameters of friction force models is accumulated during normal unloading cycles for the aircraft.

The onboard weight and balance system provides the weight and balance of the aircraft determined by the weight and balance unit as data to a flight computer of the aircraft. The pilots of the aircraft can access the weight and balance of the aircraft during and after loading/unloading of the aircraft. The flight computer can also provide warnings, via visual output, audio output, haptic output, or combinations thereof, to the pilots of the aircraft when the weight of the aircraft, the balance of the aircraft, or both, are outside of weight limits and balance limits. Additionally, the onboard weight and balance system can provide the output of the onboard weight and balance system to a load master tasked with loading/unloading the aircraft. The load master determines an estimate of the weight and balance based on empty weight of the airplane, fuel weight, cargo weight, average weights associated with passengers and aircraft crew, and average weights of baggage associated with passengers and crew, and compares weight and balance with the weight and balance provided by the onboard weight and balance system. If significant discrepancies exist between the values for weight and balance determined by the cargo master and the values provided by the onboard weight and balance system, the cause of the discrepancies can be addressed by the load master and/or pilots before releasing the aircraft for flight.

A technical advantage of the onboard weight and balance system is that the onboard weight and balance system provides repeatable, reliable, and accurate determination of a weight and CG of the aircraft while the aircraft is situated on the ground without the need for weight scales. Another technical advantage is that the onboard weight and balance system has a self-calibration feature to adjust model parameters of models to compensate for changes that occur over time (e.g., changes due to wear of bearings of the shock struts) so that the onboard weight and balance system provides usable output for an extended period of time.

The figures and the following description illustrate specific exemplary implementations. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

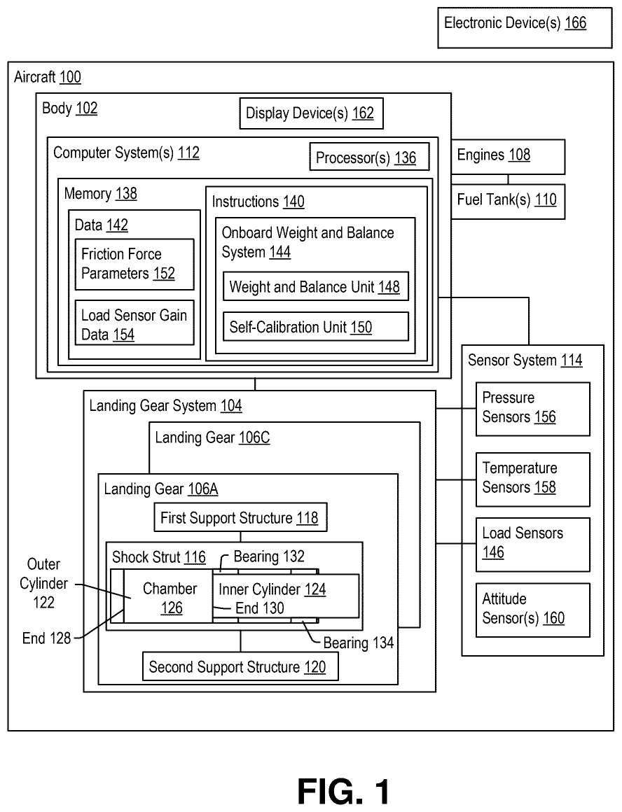

Particular implementations are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, multiple landing gear of a landing gear system 104 are illustrated and associated with reference numbers 106A-C. When referring to a particular one of the landing gear, such as the landing gear 106A, the distinguishing letter “A” is used. However, when referring to any arbitrary one of these landing gear, the reference number 106 is used without a distinguishing letter.

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts an aircraft 100 including one or more computer systems 112, which indicates that in some implementations the aircraft 100 includes a single computer system 112 and in other implementations the aircraft 100 includes multiple computer systems 112. For ease of reference herein, such features are generally introduced as “one or more features” where the description of the feature is used in place of “features” (e.g., computer systems) and subsequently referred to using “feature(s)” where the description of the feature is used in place of the feature (e.g., computer system(s)), unless a specific singular or plural feature is intended.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements. As used herein, A “and/or” B may mean that either “A and B”, or “A or B”, or both “A and B” and “A or B” are applicable or acceptable.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

FIG. 1 depicts a block diagram of an aircraft 100. The aircraft 100 includes a body 102 (e.g., a fuselage, wings, a tail section, etc.), a landing gear system 104 with multiple landing gear 106 coupled to the body 102, engines 108 coupled to the body 102 to power the aircraft 100, one or more fuel tanks 110 configured to hold fuel for the engines 108, one or more computer systems 112 within the body 102, and a sensor system 114 configured to provide data to the computer system(s) 112.

In some implementations, the landing gear system 104 includes nose landing gear 106A, right main landing gear 106B, and a left main landing gear 106C. Each landing gear 106 includes a shock strut 116 coupled to the body 102 by first support structure 118 and coupled to second support structure 120 (e.g., wheels, axles, supports, brakes, etc.) that contacts the ground when the aircraft 100 is not in flight. Each shock strut 116 is a pneumatic shock strut that includes an outer cylinder 122, an inner cylinder 124 configured to travel in the outer cylinder 122, and a gas (e.g., nitrogen) in a chamber 126 formed between an end 128 of the outer cylinder 122 and an end 130 of the inner cylinder 124. A first bearing 132 coupled to the inner cylinder 124 enables the inner cylinder 124 to move relative to the outer cylinder 122, and a second bearing 134 coupled to the outer cylinder 122 enables the inner cylinder 124 to move relative to the outer cylinder 122. Seals coupled to the second bearing 134 maintain the gas in the chamber 126. The gas in the chamber 126 is compressed or expanded by movement of the outer cylinder 122 relative to the inner cylinder 124. As described herein, the outer cylinder 122 is coupled to the first support structure 118 and the inner cylinder 124 is coupled to the second support structure 120. In other implementations, the outer cylinder 122 is coupled to the second support structure 120 and the inner cylinder 124 is coupled to the first support structure 118. The shock struts 116 also include a hydraulic system to mitigate forces applied to the aircraft 100 via the landing gear 106 during use.

The gas in each of the shock struts 116 supports a portion of the weight of the aircraft 100 when the aircraft 100 is on the ground. The gas in a shock strut 116 applies a first force directly to the end 130 of the inner cylinder 124 of the shock strut 116 equal to an effective surface area of the end 130 multiplied by the gas pressure in the chamber 126. The vertical ground load of the landing gear 106 includes the vertical shock strut load plus the weight of the inner cylinder 124 and the weight of the second support structure 120.

The computer system(s) 112 include flight control computers, one or more auxiliary computers, line-replaceable units, or combinations thereof. The computer system(s) 112 includes one or more processors 136 and memory 138. The memory 138 includes instructions 140 executable by the processor(s) 136 and data 142. The instructions 140 include numerous instructions associated with operation of the aircraft 100, including an onboard weight and balance system 144 configured to determine a weight of the aircraft 100 and a CG of the aircraft 100 when the aircraft 100 is on the ground (e.g., before, during, and after loading and unloading the aircraft 100 when the aircraft 100 is on the ground and not moving across the ground). The onboard weight and balance system 144 utilizes friction force models of friction force acting on the shock struts 116 of the landing gear system 104 and gain models of gain for load sensors 146 to determine the weight and balance of the aircraft 100. The onboard weight and balance system 144 includes a weight and balance unit 148 to determine the weight and balance of the aircraft 100 and a self-calibration unit 150 to determine updated model parameters of models used to determine the weight and balance of the aircraft 100.

The data 142 includes information used during execution of the instructions 140 by the processor(s) 136 and output generated by the processor(s) 136 during execution of the instructions 140. The data 142 is stored in data structures in the memory 138. The information used by the onboard weight and balance system 144 to determine the weight and balance of the aircraft 100 includes parameters associated with the aircraft 100, friction force parameters 152 of friction force models used to model friction force acting on the shock struts 116 at transitions of the shock struts 116 from dynamic states where the outer cylinder 122 is moving relative to the inner cylinder 124 to static states where the outer cylinder 122 is not moving relative to the inner cylinder 124, and gain parameters associated with output of the load sensors 146 in load sensor gain data 154.

The parameters associated with the aircraft 100 include information about the aircraft 100. The information about the aircraft 100 includes rake angles of the shock struts 116 when the landing gear 106 are extended (e.g., the angle of the shock strut 116 relative to a perpendicular to a fore-aft (longitudinal) axis of the aircraft 100), an effective surface area associated with ends 130 of the inner cylinders 124 of the shock struts 116, weight of the inner cylinder 124 and the weight of the second support structure 120, axial distances based on a coordinate system from a reference point to an effective contact area of the landing gear 106 with the ground for each landing gear 106, a mean aerodynamic chord associated with a wing of the aircraft 100, a longitudinal distance from the reference point to a leading edge of the mean aerodynamic chord, other information, or combinations thereof.

The sensor system 114 provides sensor data from sensors to the computer system(s) 112 for storage in the memory 138 and use by the processor(s) 136. The sensor data includes pressure data from pressure sensors 156, temperature data from temperature sensors 158, load data from the load sensors 146 associated with the landing gear system 104, and attitude data (e.g., roll angle and pitch angle) from output of one or more attitude sensors 160 associated with the aircraft 100. The computer system(s) 112 include one or more data filters for sensor data (e.g., the pressure data, temperature data, and load data) that reduce fluctuations present in the sensor data. One or more of the pressure sensors 156 and one or more of the temperature sensors 158 are coupled to each shock strut 116 of the landing gear system 104 to measure gas pressure and gas temperature in the chamber 126 of the shock strut 116.

The load sensors 146 (e.g., variable reluctance strain sensors) associated with a landing gear 106 are positioned so that the load data is indicative of a vertical load applied by the aircraft 100 to the shock strut 116. In an implementation, two load sensors 146 are coupled to a left trunnion vertical beam and two load sensors 146 are coupled to a right trunnion vertical beam associated with the nose landing gear 106A, two load sensors 146 are coupled to a main landing gear beam of the right main landing gear 106B, and two load sensors 146 are coupled to a main landing gear beam of the left main landing gear 106C.

The load sensors 146 are coupled to the aircraft 100 above the shock struts 116 to provide the load data indicative of the vertical load on the shock struts 116 of the landing gear 106. The vertical load may be modeled by a linear equation and the vertical load determined from output of a load sensor 146 is given by the equation:

$${L}_{t} = M ( {S}_{t} ) + {b}_{1} \qquad ( 1 )$$

where Lₜ is the vertical load at time t, M is the gain of the load sensor 146, b₁ is the y-intercept of the linear equation, and Sₜ is the load sensor output of the load sensor 146 at time t.

The computer system(s) 112 process raw load data received from the load sensors 146 to produce the load sensor output. The raw load data input for a load sensor 146 is processed based on calibration data for the load sensor 146. The load sensor gain data 154 stores a gain for each load sensor 146 as a function of the load data input in a table of calibration data for each load sensor 146. The table for a load sensor 146 includes incremental gain data values as a function of the load data input on the associated shock strut 116 when the load sensor 146 was calibrated for incremental values of raw data that increase by a particular increment value (e.g., 5, 10, 20, 40, or some other increment value). To determine the load sensor output of the load sensor 146 based on load data input received from the load sensor 146, the computer system(s) 112 determine the gain corresponding to the load data input from the table and multiplies the gain by the load data input. Linear interpolation, or another estimation technique, is used to determine the gain the table if the load data input is between values presented in the table for the load sensor 146.

The load sensors 146 are too sensitive to allow the use of the values of the vertical load determined as the load sensor outputs at a particular time as the values for the vertical loads on the corresponding shock struts 116 at the particular time; although, delta loads determined for short time spans from the load sensor outputs are useful estimates of the change to the vertical load on the corresponding shock struts 116. For each landing gear 106, the onboard weight and balance system 144 determines a delta load based on the load data inputs from the one or more load sensors 146 and the gain associated with the load sensor 146 to determine the changes in vertical loads applied to the shock strut 116 of the landing gear 106 during a static state (e.g., from a first time of a transition of the shock strut 116 from a first dynamic state to a static state to a subsequent transition from the static state to a second dynamic state) up to a second time associated with a next transition of the shock strut 116 from a dynamic state to a static state. The equation to determine the delta load on the shock strut 116 based on the load sensor output of a load sensor 146 associated with the shock strut 116 during a time range from a first time t1 (e.g., a time of a transition of the shock strut from a dynamic state to a static state) to a second time t2 that is subsequent to the first time is:

$$Δ {LS}_{t 1 , t 2} = M ( {S}_{t 2} - {S}_{t 1} ) \qquad ( 2 )$$

where ΔLS_{t1,t2} is the delta load based on the load sensor output that indicates the change in vertical load on the shock strut 116 from the first time to the second time, Sₜ₂ is the load sensor output at the second time, and Sₜ₁ is the load sensor output at the first time. Equation (2) is a gain model for a load sensor 146 of a landing gear 106 associated with a shock strut 116. Equation (2) is used to determine the delta load from the first time (e.g., a first time of a transition of the shock strut 116 from a dynamic state to a static state) to a second time at or after the first time (e.g., up to start of a next dynamic state when the pressure changes and the inner cylinder 124 of the shock strut 116 moves relative to the outer cylinder 122). The delta load indicates a change in vertical load applied to the shock strut 116.

The attitude sensor(s) 160 can be part of an inertial navigation system of the aircraft 100 or can be a separate system. When the aircraft 100 is on the ground, the attitude sensor(s) 160 indicate a pitch angle of the aircraft 100. The onboard weight and balance system 144 uses appropriate trigonometric relations to compensate for the pitch angle when determining the weight and balance of the aircraft 100.

The computer system(s) 112 provide output based on output of the weight and balance unit 148 to output devices. The output devices include one or more display devices 162 of the aircraft 100 (e.g., flight displays and one or more displays located in cargo holds of the aircraft 100 accessible by personnel associated with loading/unloading of the aircraft 100), one or more external electronic devices 166 (e.g., an electronic flight book, a portable device associated with a load master tasked with loading or unloading the aircraft 100, etc.), audio devices, haptic devices, other types of output devices, or combinations thereof. The output can include the gross weight of the aircraft 100, the zero fuel weight of the aircraft 100 (i.e., gross weight minus fuel weight), the location of the center of gravity of the aircraft 100, warnings associated with the weight of the aircraft 100, warnings associated with the center of gravity of the aircraft 100, other information, or combinations thereof.

During use of the aircraft 100, the onboard weight and balance system 144 is used to determine the weight and balance of the aircraft 100. The weight and balance unit 148 of the onboard weight and balance system 144 determines the gross weight of the aircraft 100 at a particular time using the following equation:

$${GW}_{t} = {\sum }_{i}^{n} {F}_{V , t , i} \qquad ( 3 )$$

where GWₜ is the gross weight of the aircraft 100 at the particular time, i is an index for landing gear 106 of the aircraft 100, n is the number of landing gear 106, and F_{V,t,i} is a vertical force of landing gear i on the ground at the particular time.

The balance of the aircraft 100 at the particular time, which is expressed as the CG of the aircraft 100 relative to one or more axes of a three-dimensional rectangular coordinate system, with a reference point at an origin of the coordinate system, is based on moments of the vertical forces on the landing gear 106 relative to the reference point and the gross weight of the aircraft 100. For an airplane, the CG calculations are typically performed only along a longitudinal axis of the coordinate system. The longitudinal axis is aligned with the fore-to aft direction of the aircraft and is orthogonal to a vertical axis (i.e., a height axis) through the reference point and the center of the earth. For other aircraft 100 (e.g., helicopters) and for some airplanes, the CG calculations are performed along a longitudinal axis and a side-to-side axis of the coordinate system that is orthogonal to the longitudinal axis and the vertical axis. The equation for the center of gravity of the aircraft 100 relative to the reference point for the longitudinal axis of the aircraft at a particular time is:

$${CG}_{long , t} = \frac{{\sum }_{i}^{n} ( {F}_{V , t , i} ) ( {d}_{long , i} ) ( cos θ )}{{GW}_{t}} \qquad ( 4 )$$

where CG_{long,t} is the center of gravity of the aircraft along the longitudinal axis relative to the reference point at the particular time, d_{long,i} is the distance from the effective contact point of the landing gear i on the ground to the reference point along the longitudinal axis, and θ is the pitch angle of the aircraft 100. For an aircraft 100 with two main landing gear 106B, 106C at a distance from the reference point, and a nose landing gear 106A, the longitudinal CG at the particular time is:

$${CG}_{long , t} = {d}_{M} - \frac{{F}_{N , t} ( {d}_{M} - {d}_{N} )}{{GW}_{t}} + {CG}_{height , t} sin θ \qquad ( 5 )$$

where dm is the distance from the reference point to the effective contact point of the main landing gear 106B, 106C on the ground along the longitudinal axis, F_{N,t} is the vertical force on the nose landing gear at the particular time, d_{N} is the distance from the reference point to the effective contact point of the nose landing gear 106A on the ground along the longitudinal axis, and CG_{height,t} is the height center of gravity of the aircraft 100 along the vertical axis relative to the ground at the particular time.

In some implementations, the longitudinal CG is expressed as a percentage of mean aerodynamic cord of the aircraft 100. The percentage of mean aerodynamic cord is determined by the equation:

$${CG ( \% MAC )}_{t} = \frac{100 ( {CG}_{long , t} - LeMAC )}{MAC} \qquad ( 6 )$$

where CG (% MAC) t is the percentage of mean aerodynamic cord at the particular time, LeMAC is the distance from the leading edge of the mean aerodynamic cord to the reference point along the longitudinal axis, and MAC is the mean aerodynamic cord.

For implementations where the side-to-side balance is determined, the weight and balance unit 148 determines the center of gravity of the aircraft 100 at the particular time relative to the reference point for the side-to-side axis of the aircraft 100 using the equation:

$${CG}_{s - to - s , t} = \frac{{\sum }_{i}^{n} ( {F}_{V , t , i} ) ( {d}_{s - to - s , i} ) ( cos θ )}{{GW}_{t}} \qquad ( 7 )$$

where CG_{s-to-s,t} is the center of gravity of the aircraft 100 along the side-to-side axis relative to the reference point at the particular time, d_{s-to-s,i} is the distance from the effective contact point of the landing gear i on the ground to the reference point along the side-to-side axis, and Ø is the roll angle of the aircraft 100.

The vertical force on one of the landing gear 106 is the vertical force applied to the shock strut 116 of the landing gear 106 plus weight of the landing gear 106 not supported by the gas of the shock strut 116 (e.g., the inner cylinder 124 of the shock strut 116, wheels, tires, axles, supports, brakes, etc.). The vertical force on a particular landing gear 106 on the ground at a particular time is determined using the equation:

$${F}_{V , t} = {L}_{t} + {M}_{UN} \qquad ( 8 )$$

where Lₜ is the vertical load on the shock strut 116 of the particular landing gear 106 supported by the gas in the shock strut 116 at the particular time and M_{UN} is the weight of the particular landing gear 106 unsupported by the gas of the shock strut 116, which is stored in the data 142 as one of the parameters associated with the aircraft 100.

For a shock strut 116 at a transition from a dynamic state to a static state, the load on the shock strut 116 supported by the gas in the shock strut 116 is countered by the force due to the pressure in the shock strut 116 acting on the end 130 of the inner cylinder 124 multiplied by the effective area of the end 130 of the inner cylinder 124 and the friction force. When the dynamic state starts, the pressure of the gas rapidly changes; and, at the transition to the static state, the gas pressure becomes relatively constant (e.g., the gas pressure reaches a constant value at the transition, but the gas pressure at times near the transition can fluctuate due to temperature effects), which allows the onboard weight and balance system 144 to determine the transition for the shock strut 116 based on analysis of the gas pressure data, the gas temperature data, time, or combinations thereof.

The friction force at the transition is a function of the pressure of the gas in the chamber 126 and the temperature of the gas in the chamber 126. The friction force is modeled by a linear equation for a given temperature, or limited temperature range. At the transition of the shock strut 116 from the dynamic state to the static state, the force on the shock strut 116 of a particular landing gear 106 is given by the equation:

$${F}_{S , T} = {P}_{T} A + {F}_{F} = {P}_{T} A + ( {mP}_{T} + b ) = {P}_{T} ( A + m ) + b \qquad ( 9 )$$

where F_{S,T} is the load on the shock strut 116 of the particular landing gear 106 at the transition, P_{T} is the gas pressure in the shock strut 116 of the particular landing gear 106 at the transition, A, which is a parameter associated with the aircraft 100 stored in the data 142, is the effective surface area of the end 130 of the inner cylinder 124 of the shock strut 116 of the particular landing gear 106, F_{F} is the friction force for the shock strut 116 of the particular landing gear 106 at the transition, where (mP_{T}+b) is a linear friction force model for the friction force, m is the slope of the friction force model of the shock strut 116 at the transition, and b is the y-intercept of the friction force model of the shock strut 116 at the transition.

The friction force parameters 152 in the data 142 include first sets of values of slope and y-intercept for loading the aircraft 100 and second sets of values of slope and y-intercept for unloading the aircraft 100 for each shock strut 116 of the landing gear system 104. Each first set of parameters of the first sets and each second set of parameters of the second sets for a particular shock strut 116 is associated with a particular temperature range of gas temperature in a working temperature range of the shock strut 116. When the onboard weight and balance system 144 uses the friction model parameters for one of the shock struts 116 at a transition from a dynamic state to a static state, the onboard weight and balance system 144 determines a particular set of parameters to use based on the gas temperature at the transition, determines to use the corresponding first set of parameters when the pressure during the dynamic state increased, determines to use the corresponding second set of parameters when the pressure during the dynamic state decreased, and retrieves the appropriate parameters from the friction force parameters 152.

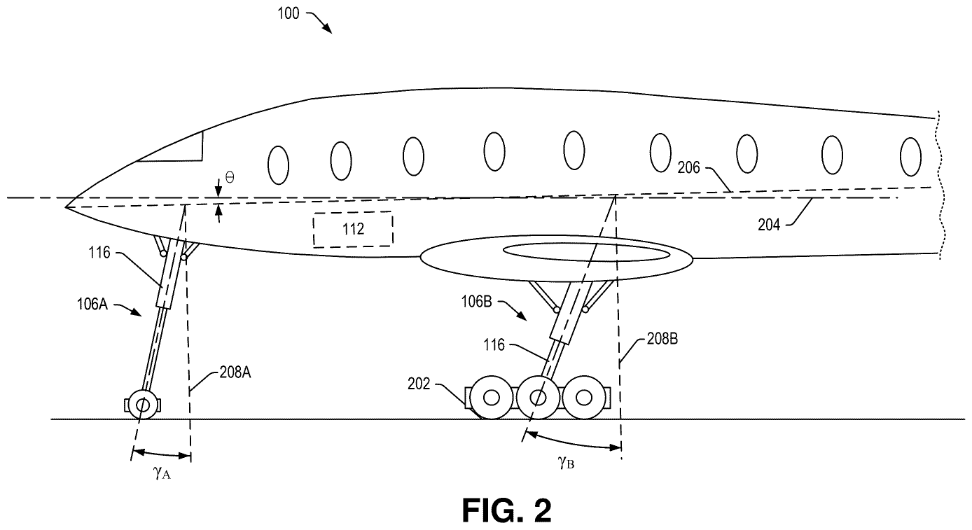

At transitions of the shock strut 116 from dynamic states to static states for each of the landing gear 106, the vertical component of the force on the shock strut 116 of the landing gear 106 is:

$${L}_{T} = \frac{{F}_{S , T}}{cos ( γ - θ )} = \frac{{P}_{T} ( A + m ) + b}{cos ( γ - θ )} \qquad ( 10 )$$

where L_{T} is the vertical component of the force on the shock strut 116 at a transition of the shock strut from a dynamic state to a static state, and γ is the rake angle of the shock strut 116 of the landing gear 106. The rake angles of the shock struts 116 are parameters associated with the aircraft 100 stored in the data 142. The rake angle of a shock strut 116 is a positive value when the shock strut 116 is raked toward a nose of the aircraft 100 (e.g., the shock struts 116 of FIG. 2 are raked toward the nose of the aircraft 100, and the rake angles of the shock struts 116 of landing gear 106A, 106B in FIG. 2 both have positive values).

After the transition from the dynamic state to the static state for a shock strut 116 of a landing gear 106, any load change due to further loading or unloading of the aircraft 100 will change the static friction force until loading or unloading stops, or a breakout compression friction force or a breakout expansion friction force is crossed and the shock strut 116 transitions to a dynamic state and subsequently transitions to a subsequent static state. During the subsequent static state, load data is used to determine load added to, or removed from, the shock strut 116 based on the load sensor output of the one or more load sensors 146 for the landing gear 106 associated with the shock strut 116.

Using equation (10) to determine the vertical force on the shock strut 116 at the transition from a dynamic state to a static state and equation (2) to determine the delta load during the static state, the vertical component of the force on the shock strut 116 of the landing gear 106 at the first time after the transition is determined using the equation:

$${L}_{T} = {L}_{T} + Δ {LS}_{t , T} = \frac{{P}_{T} ( A + m ) + b}{cos ( γ - θ )} + M ( {S}_{t} - {S}_{T} ) \qquad ( 11 )$$

where Lₜ is the vertical component of the force on the shock strut 116 of the landing gear 106 at the first time, which is a time from the transition when motion of the inner cylinder 124 of the shock strut 116 relative to the outer cylinder 122 stops up to a time associated with a subsequent transition from the static state to a dynamic state when motion of the inner cylinder 124 of the shock strut 116 relative to the outer cylinder 122 starts or until completion of loading/unloading of the aircraft 100, ΔLS_{t,T} is the delta load based on the load sensor output that indicates the change in vertical load on the shock strut 116 from the transition to the first time, Sₜ is the load sensor output at the first time, and S_{T} is the load sensor output at the transition. The appropriate friction force parameters for the slope and y-intercept are obtained from the friction force parameters based on the gas temperature at the transition and based on pressure behavior during the dynamic state immediately preceding the transition. The appropriate gains for the load sensor output utilized when determining the vertical load on the shock struts 116 via equation (11) are obtained from the load sensor gain data 154 for one or more load sensors 146 that provide the load sensor output.

The onboard weight and balance system 144 determines initial data associated with initial transitions from dynamic states to static states for each shock strut 116 of the landing gear system 104. The initial data includes, for each landing gear 106, the vertical component of the force on the shock strut 116 of the landing gear 106 at a most recent transition from a dynamic state to a static state or an estimate of the most recent transition, and the corresponding load sensor output associated with the landing gear 106. When the aircraft 100 is powered up from a powered-down state while on the ground, the initial data is retrieved from the data 142 in the memory 138 from data saved by the computer system(s) 112 from the last use of the onboard weight and balance system 144. When the aircraft 100 lands after a flight and taxies to a location where the aircraft 100 is to be fueled, unloaded, loaded, or combinations thereof, the computer system(s) determine the gross weight and the CG as initial data based on the corresponding gas pressures for the shock struts from the pressure data and the parameters of the friction force models for the shock struts 116 from the first sets of values for the corresponding gas temperatures for the shock struts 116 from the temperature data.

During loading/unloading of the aircraft 100, the weight and balance unit 148 uses the initial data and subsequently collected sensor data to determine the weight and balance of the aircraft 100 by determining the vertical loads on the shock struts 116 of the landing gear system 104 using equation (11). Each time a shock strut 116 is at a transition from a dynamic state to a static state, the value in equation (11) corresponding to the vertical weight on the shock strut 116 based on the friction force is recalculated based on the slope and the y-intercept parameters associated with the transition, and the pressure at the transition. The set of parameters in the friction force parameters 152 that include the slope and the y-intercept parameters associated with the transition are determined based on the gas temperature at the transition, and pressure behavior during the dynamic state of the shock strut preceding the transition.

When the vertical loads on the shock struts 116 of the landing gear system 104 are determined for all the landing gear 106 at a particular time, the weight and balance unit 148 determines the vertical load on the ground for each landing gear 106 at the particular time via equation (8), and then the gross weight of the aircraft 100 via equation (3). The CG of the aircraft 100 is determined at the particular time via one or more of equations (4)-(7). The weight and balance unit 148 provides output of the gross weight and one or more CG values to the computer system(s) 112.

The computer system(s) 112 of the aircraft 100 utilize the output (e.g., the gross weight of the aircraft 100 and the balance of the aircraft) of the onboard weight and balance system 144 to determine whether one or more alerts should be generated based on comparison of the values for the weight and balance to thresholds, and the computer system(s) 112 provide appropriate alerts to output devices (e.g., the display devices 162, the electronic devices 166, audio systems, haptic systems, or combinations thereof). In some implementations, the computer system(s) 112 prevents further aft movement of cargo by removing power from cargo handling system when the output of the onboard weight and balance system 144 indicates the weight, the balance, or both, of the aircraft 100 exceed critical thresholds until personnel associated with the aircraft 100 resolve issues associated with the weight, the balance, or both. The computer system(s) 112 provide, upon request by a pilot, numerical and graphic indications of the weight, the balance, or both, as output to the display device(s) 162.

The self-calibration unit 150 determines updated values of model parameters of the friction force models and the gain model for each of the load sensors 146 based on calibration data. The self-calibration unit 150 replaces the values of friction force parameters 152 of the friction force models with the updated values based on satisfaction of one or more first thresholds. The self-calibration unit 150 replaces the parameters of gain in the load sensor gain data 154 associated with the load sensors 146 based on satisfaction of one or more second thresholds. The self-calibration unit 150 stores the calibration data in the data 142 when the weight and balance unit 148 is being used to determine the weight and balance of the aircraft 100.

The self-calibration unit 150 is operational during operation of the weight and balance unit 148 to identify the calibration data. In some implementations, the processor(s) include one or more particular processors 136 dedicated to executing the self-calibration unit 150, and the self-calibration unit 150 performs operations to determine the updated parameters and the gains when there is unprocessed calibration data stored in the data 142. In other implementations, particular instructions 140 monitor the workload of the processor(s) 136 and task a particular set of one or more particular processors of the processor(s) 136 that have a current workload below a threshold level to perform the operations to determine the updated parameters and gains when there is unprocessed calibration data stored in the data 142.

The self-calibration unit 150 accumulates calibration data during operation of the weight and balance unit 148. The calibration data includes an identifier of a particular shock strut 116, particular data associated with a transition of the particular gas strut from a dynamic state to a static state (e.g., pressure at the transition, temperature at the transition, load sensor output of one or more load sensors 146 associated with the shock strut 116 at the transition, and pitch of the aircraft 100), a pointer to calibration data associated with the previous transition of the shock strut 116 from a dynamic state to a static state during the same loading/unloading cycle, an indicator of whether the transition is associated with loading of the aircraft 100 or unloading of the aircraft 100, an indicator of whether the transition occurred during fueling or defueling of the aircraft 100, other data, or combinations thereof. In some implementations, calibration data associated with fueling of the aircraft 100 is used exclusively in determining updated parameters of the friction force models for first sets of parameters associated with loading of the aircraft 100 and other calibration data for loading of the aircraft 100 is ignored. In other implementations, calibration data associated with fueling of the aircraft 100 or defueling of the aircraft 100 is weighted by a particular factor when the updated parameters for first sets of friction models associated with loading the aircraft 100 and second sets of friction models associated with unloading of the aircraft 100 are determined.

The friction force parameters 152 include the first sets of slope and y-intercept parameters for loading the aircraft 100 and the second sets of slope and y-intercept parameters for unloading the aircraft 100. Further, the first sets and the second sets include individual sets of parameters associated with different temperature ranges. The load sensor gain data 154 includes a gain for each load sensor 146 associated with the landing gear system 104. The self-calibration unit 150 separates the calibration data into calibration data sets corresponding to particular temperature ranges based on the temperature data of the calibration data

In an implementation, a running average of the slope and the y-intercept are kept in the friction force parameters 152 as updated values of the slope and the y-intercept by the self-calibration unit 150 for each set of parameters for a particular number of transitions from a dynamic state to a static state associated with the set. The running average for a set is updated for each detected transition from a dynamic state to a static state associated with the set. The slope and y-intercept are determined for a transition associated with the set based on the transition and a nearest previous transition associated with the same loading/unloading cycle. The particular set associated with a transition is based on the gas temperature at the transition and whether the transition is associated with loading (e.g., the gas pressure during the dynamic state increased) or unloading (e.g., the gas pressure during the dynamic state decreased) of the aircraft 100. The self-calibration unit 150 uses the load sensor output from the one or more load sensors 146 associated with the shock strut 116 of the corresponding landing gear 106 at the transition and the nearest previous transition to determine the slope and y-intercept.

The slope of the friction force model of a shock strut 116 is given by the equation:

$$m = \frac{Δ {F}_{F}}{Δ P} = \frac{( {F}_{S , T 2} - {P}_{T 2} A ) - ( {F}_{S , T 1} - {P}_{T 1} A )}{Δ P} = \frac{Δ {F}_{S}}{Δ P} - A \qquad ( 12 )$$

where ΔF_{F} is the friction force at the transition less the friction force at the nearest previous transition, ΔP is the gas pressure in the shock strut 116 at the transition less the gas pressure in the shock strut 116 at the nearest previous transition, F_{S,T2} is the force on the shock strut 116 at the transition, P_{T2} is the gas pressure of the shock strut 116 at the transition, F_{S,T1} is the force on the shock strut 116 at the nearest previous transition, P_{T1} is the gas pressure of the shock strut 116 at the nearest previous transition, and ΔF_{S} is the force on the shock strut 116 at the transition less the force on the shock strut 116 at the nearest previous transition.

Substituting the relation for the vertical load on the shock strut 116 in place of the force on the shock strut 116 in the equation (12) and the delta load from equation (3) results in the following equation used by the self-calibration unit 150 to determine the slope of the model for the friction force of the shock strut 116:

$$m = \frac{Δ {LS}_{T 1 , T 2} cos ( γ - θ )}{Δ P} - A = \frac{M ( {S}_{T 2} - {S}_{T 1} ) cos ( γ - θ )}{Δ P} - A \qquad ( 13 )$$

where ΔLS_{T1,T2} is the delta load based on the load sensor output that indicates the change in vertical load on the shock strut 116 from the transition to the nearest previous transition, S_{T2} is the load sensor output at the transition, and S_{T1} is the load sensor output at the nearest previous transition.

The y-intercept for the model for the friction force of the shock strut 116 is given by the equation:

$$b = {F}_{F , T 2} - {mP}_{T 2} = ( {F}_{S , T 2} - {P}_{T 2} A ) - {mP}_{T 2} = {F}_{S , T 2} - ( A + m ) {P}_{T 2} \qquad ( 14 )$$

where F_{F,T2} is the friction force at the second transition, P_{T2} is the gas pressure in the shock strut 116 at the second transition, and F_{S,T2} is the force on the shock strut 116 at the second transition.

Substituting the relation for the vertical load on the shock strut 116 in place of the force on the shock strut 116 in equation (14) results in the following equation used by the self-calibration unit 150 to determine the y-intercept of the model for the friction force of the shock strut 116:

$$b = {LS}_{T 2} cos ( γ - θ ) - ( A + m ) {P}_{T 2} = M ( {S}_{T 2} ) cos ( γ - θ ) - ( A + m ) {P}_{T 2} \qquad ( 15 )$$

where LS_{T2} is the load based on the load sensor output at the transition, and S_{T2} is the load sensor output at the transition. Although the value of LS_{T2} may not be an accurate value for the vertical load on the shock strut, the value of LS_{T2} is on the line of the linear model for the friction force. Calculation of the slope and y-intercept using equation (13) and equation (15) assumes that an offset (y-intercept) associated with the load sensor output may vary significantly over time, but the gain (i.e., the slope M) and the y-intercept associated with the load sensor output used to determine the delta load are substantially constant for the range of load sensor output of the load sensor 146 from the transition to the nearest previous transition.

A new value of the slope determined using equation (13) is used to update a running average based on a maximum of n values for the slope using first calculations and a new value of the y-intercept determined using equation (15) is used to update a running average based on a maximum of n values using second calculations. When k used to form the running average for the slope and the y-intercept is less than n, the running average for the slope and the running average for the y-intercept are multiplied by k to generate respective sums, the new value for the slope and the y-intercept are added to the corresponding sum, k is increased by 1, and the running average for the slope and the y-intercept are calculated respectfully as the corresponding sum divided by k. When k used to form the previous running average for the slope and the previous running average for the y-intercept is n, the oldest value for the slope divided by n and the oldest value for the y-intercept divided by n are subtracted from the corresponding running averages, a particular value of the new slope divided by n and a particular value of the y-intercept divided by n are determined, and the running averages for the slope and the y-intercept are determined by adding the respective particular values to the corresponding running averages. The running average of the slope for a set is the updated value of the slope for the set and the running average of the y-intercept for the set is the updated value of the y-intercept for the set. When the self-calibration unit 150 utilizes weighted values for slopes and y-intercepts determined from data obtained during fueling or defueling of the aircraft 100, the self-calibration unit 150 adjusts the value of n to compensate for the weighted values when determining the updated values for the slopes and y-intercepts of the friction force models.

In another implementation, for each set of parameters of slope and y-intercept for a friction force model, the self-calibration unit 150 determines updated values for the slope and the y-intercept for a maximum of n transitions from dynamic states to static states using linear regression equations for the slope and y-intercept based on calculated friction force and measured pressure data for the transitions. For each set of parameters, the self-calibration unit 150 determines the following running sums for each transition from a dynamic state to a static state for the set:

$${s}_{1} = {\sum }_{i = 1}^{j} ( {P}_{i} ) ( {F}_{F , i} ) \qquad ( 16 )$$

$${s}_{2} = {\sum }_{i = 1}^{i} {P}_{i} \qquad ( 17 )$$

$${s}_{3} = {\sum }_{i = 1}^{j} {F}_{F , i} \qquad ( 18 )$$

$${s}_{4} = {\sum }_{i = 1}^{j} ( ( {P}_{i} ) ( {P}_{i} ) ) \qquad ( 19 )$$

where s₁ is a first running sum, i is an index, j is the current number of transitions for the shock strut 116, Pᵢ is the gas pressure at transition i, F_{F,i} is the friction force at transition i, s₂ is a second running sum, s₃ is a third running sum, and s₄ is a fourth running sum.

When a new transition for the set is detected and j is less that n, j is increased by 1 and the running sums are determined using equations (16)-(19). When a new transition for the set is detected and j is n, the running sums are recalculated by subtracting the corresponding values based on the oldest transition and adding the corresponding values based on the new transition. New values for the slope and y-intercept for the set, which are the updated values, are determined via the following equations:

$$m = \frac{j ( {s}_{1} ) - ( {s}_{2} ) ( {s}_{3} )}{j ( {s}_{4} ) - ( {s}_{2} ) ( {s}_{2} )} \qquad ( 20 )$$

$$b = \frac{{s}_{3} - ( m ) ( {s}_{2} )}{J} \qquad ( 21 )$$

When the self-calibration unit 150 utilizes weighted values of the gas pressures at transitions and weighted values of friction forces at the transitions in equations (16)-(19) to increase relevance associated with gas pressures and friction forces associated with fueling or defueling of the aircraft 100, the self-calibration unit 150 adjusts the value of n to compensate for the weighted values when determining the running sums s₁-s₄.

For each load sensor 146 of a landing gear 106 associated with a shock strut 116, the self-calibration unit 150 determines a running average of the gain, M, for q transitions of the shock strut 116 from a dynamic state to a static state based on calculated vertical loads on the shock strut 116 and the load sensor output as an updated gain. For a particular load sensor 146, the self-calibration unit 150 determines the gain for a transition of the shock strut 116 associated with the load sensor 146 using the equation:

$$M = \frac{Δ {L}_{T 1 , T 2}}{Δ {s}_{T 1 , T 2}} = \frac{Δ P ( A + m )}{( cos ( γ - θ ) ) Δ {S}_{T 1 , T 2}} \qquad ( 22 )$$

where ΔL_{T1,T2} is the calculated vertical load for the transition based less the calculated vertical load for the nearest previous transition and ΔS_{T1,T2} is the load sensor output of the load sensor 146 at the transition less the load sensor output of the load sensor 146 at the nearest previous transition.

A new value of the gain determined using equation (22) is used to update a running average for the gain based on a maximum of q values for the gain. When the value of k used to form the running average is less than q, the running average is multiplied by k to generate a sum, the new value for the gain is added to the sum, k is increased by 1, and the running average is calculated as the sum divided by k. When k used to form the previous running average is q, the oldest value for the gain divided by q is subtracted from the running average, a particular value of the new gain divided by q is determined, and the running average is determined by adding the particular value to the running average. The running average of the gain associated with each load sensor 146 is the updated gain for the load sensor 146.

The self-calibration unit 150 replaces parameters for the slopes and the y-intercepts in the friction force parameters 152 with the updated parameters for the friction force models in response to satisfaction of one or more thresholds for the friction force models. In some implementations, the one or more thresholds include a time-of-use threshold (e.g., 1 month, 2 month, 6 months, or some other period of time) from start of use of the aircraft 100 or a previous replacement of the parameters. All the slope and y-intercept parameters, or the slope and y-intercept parameters where the number of values used to form the running average is above a particular threshold (e.g., 5, 10, or some other value), are replaced after the passage of time exceeds the time-of-use threshold. In some implementations, the one or more thresholds include a number of transitions threshold for the shock struts 116. All the slope and y-intercept parameters associated with the friction force models for a particular shock strut 116, or the slope and y-intercept parameters for the particular shock strut 116 for sets where the number of values used to form the running average is above a particular threshold (e.g., 5, 10, or some other value), are replaced when the number of transitions threshold for the particular shock strut 116 is exceeded, and a number of transitions counter for the particular shock strut 116 is reset to zero. In other implementations, other thresholds and conditions are used in determining whether to replace one or more slope and y-intercept parameter sets in the friction force parameters 152 with the updated slope and the updated y-intercept.

The self-calibration unit 150 replaces parameters for the gains associated with load sensors 146 with the updated gains in the load sensor gain data 154 based on satisfaction of one or more thresholds. In some implementations, the one or more thresholds include a time-of-use threshold that is satisfied after passage of a particular amount of time (e.g., 1 month, 2 month, 6 months, or some other period of time) from start of use of the aircraft 100 or a previous replacement of the parameters. In some implementations, the one or more thresholds include a number of transitions threshold for the shock struts 116 associated with load sensors 146. The gains in the load sensor gain data 154 for the load sensors 146 associated with a particular shock strut 116 are replaced when the number of transitions for the particular shock strut 116 exceeds the number of transitions threshold for the particular shock strut 116, and a number of transitions counter for the particular shock strut is reset to zero. In some implementations, the thresholds include a threshold range for an error metric based on the current gain and the updated gain when the running average for the updated gain is based on more than a minimum number of transitions. In some implementations, the error metric is one minus the ratio of the current gain to the updated gain, and the threshold range is plus or minus 0.1, plus or minus 0.05, plus or minus 0.025, or plus or minus some other value. The self-calibration unit 150 replaces the current gain with the updated gain when the error metric is outside of the threshold range. In other implementations, other thresholds and conditions are used in determining whether to replace one or more gains in the load sensor gain data 154 with the updated gains.

FIG. 2 depicts a side view representation of a portion of an implementation of the aircraft 100 on ground 202. The ground 202 depicted in FIG. 2 is level relative to an earth-based coordinate system having a first axis 204; a second axis orthogonal to the first axis 204; and a third axis orthogonal to the first axis 204, the second axis, and passing through the center of the earth. In other situations, the ground 202 may be at a non-zero angle relative to the first axis 204, the second axis, or both. The aircraft 100 includes a fore-aft axis 206, which is a longitudinal axis of the aircraft 100 relative to a coordinate system of the aircraft 100, and the pitch angle, θ, is the angle between the first axis and the fore-aft axis 206.

Friction surfaces (e.g., the outer surface of the inner cylinder 124, the inner surface of the outer cylinder 122, and contact surfaces of the bearings 132, 134) of the shock strut 116 of the nose landing gear 106A have a first rake angle, γ_{A}, relative to an aircraft coordinate system (e.g., relative to a perpendicular 208A to the fore-aft axis 206). In the implementation of FIG. 2, the main landing gear 106B, 106C are each offset from a reference point the same longitudinal distance and are offset the same side-to-side distance from the first axis 204. Each of the friction surfaces of the main landing gear 106B, 106C are at a second rake angle, γ_{B}, relative to the aircraft coordinate system (e.g., relative to a perpendicular 208B to the fore-aft axis 206). Values of the rake angles γ_{A}, γ_{B} and the offset distances are part of a landing gear configuration for the aircraft 100 and are stored in the data 142 of the memory 138. The values are used by the onboard weight and balance system 144 to determine the weight and CG of the aircraft 100. In some implementations, one or both of rake angles YA, YB are zero.

The computer system(s) 112 depicted in FIG. 2 are represented in dashed lines to indicate that the computer system(s) 112 are not visible from the outside of the aircraft 100. The computer system(s) 112, during execution of the onboard weight and balance system 144 by the processor(s) 136, determines the weight and balance of the aircraft 100.

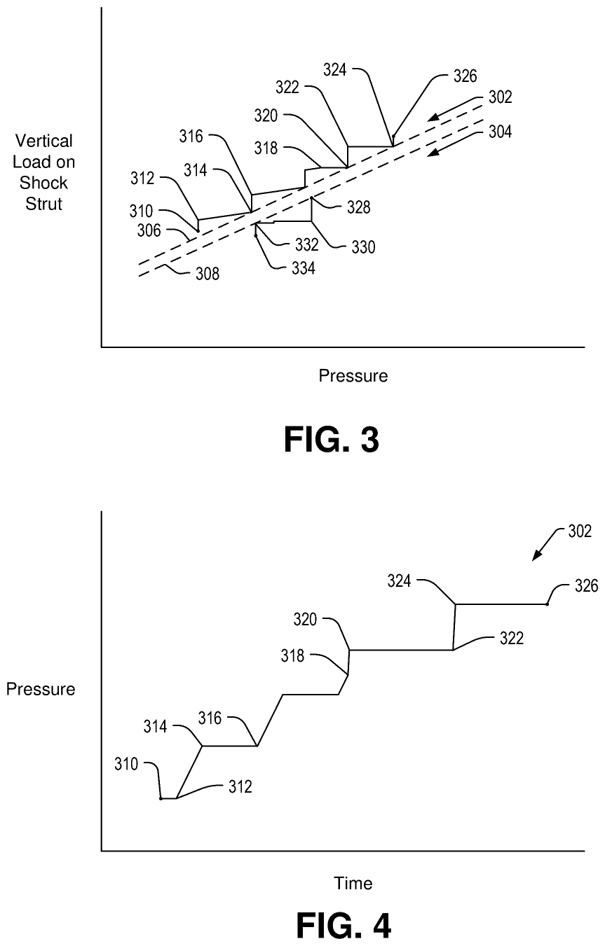

FIG. 3 depicts an idealized representation of vertical load on a shock strut versus pressure diagram for a shock strut 116 of an aircraft 100 during a portion of a particular loading cycle 302 and during a portion of a particular unloading cycle 304 of the aircraft 100. Different loading cycles and unloading cycles will result in different pressure responses. Line 306 is a line generated via equation (10), which is based on the slope and the y-intercept of a first set of parameters of a friction force model for the shock strut 116 associated with a particular temperature range of gas temperature in the shock strut 116 during loading of the aircraft. Line 308 represents a line generated via equation (10), which is based on the slope and the y-intercept of a second set of parameters of a friction force model for the shock strut 116 associated with the particular temperature range of gas temperature in the shock strut 116 during unloading of the aircraft 100.

A first portion of the loading cycle 302 includes a portion where the aircraft 100 was fueled at a particular mass rate. The fueling started at point 310 and the vertical load increased while the pressure remained constant until crossing of a breakout compression friction force at point 312. At point 312, the pressure began to increase while the vertical load continued to increase. The shock strut 116 was in a dynamic state from point 312 to point 314. Point 314 is a transition from the dynamic state to a static state for the shock strut 116, and the fuel being added to the aircraft 100 continued to increase the vertical load on the shock strut 116 while the pressure remained constant until the next breakout compression friction force is crossed at point 316. The cycle repeats until fueling stops at point 318.

In the implementation depicted in FIG. 3, no additional load is added to the shock strut 116 before the shock strut 116 transitions to another static state at point 320. After the time corresponding to point 320, additional vertical load was applied batchwise to the shock strut 116 until the load at point 322 passed another breakout compression friction force. During a dynamic state from point 322 to point 324, no additional load was applied to the shock strut 116. After point 324, some additional load was applied to raise the vertical load to the load corresponding to point 326, but another breakout compression friction force was not exceeded at point 326, so the pressure did not increase.

During the unloading cycle 304, the vertical load applied to the shock strut 116 was reduced batchwise by removal of cargo from the aircraft 100 starting at point 328 and the pressure remained constant until crossing of a breakout expansion force when the removal of particular cargo caused the vertical load indicated by point 330. During a dynamic state from point 330 to a transition to a static state at 332, an additional reduction of the vertical load occurred, which caused an additional reduction in pressure. After point 332, additional reduction of the aircraft load caused the load corresponding to point 334, but this reduction did not cause another cross of a breakout expansion force, so the pressure did not change from point 332 to point 334.

FIG. 4 depicts an idealized representation of a pressure versus time diagram for the shock strut 116 of the aircraft 100 during the portion of the loading cycle 302 depicted in FIG. 3. Points 310-326 of FIG. 3 occurred at the corresponding times indicated by points 310-326 in FIG. 4. FIG. 4 indicates that an analysis of pressure versus time data for the shock struts 116 of the landing gear system 104 of the aircraft 100 enables determinations of times of transitions from dynamic states to static states. The transitions 314, 320, and 324 are indicated by a stop of an increase in pressure and a start of constant pressure in FIG. 4.

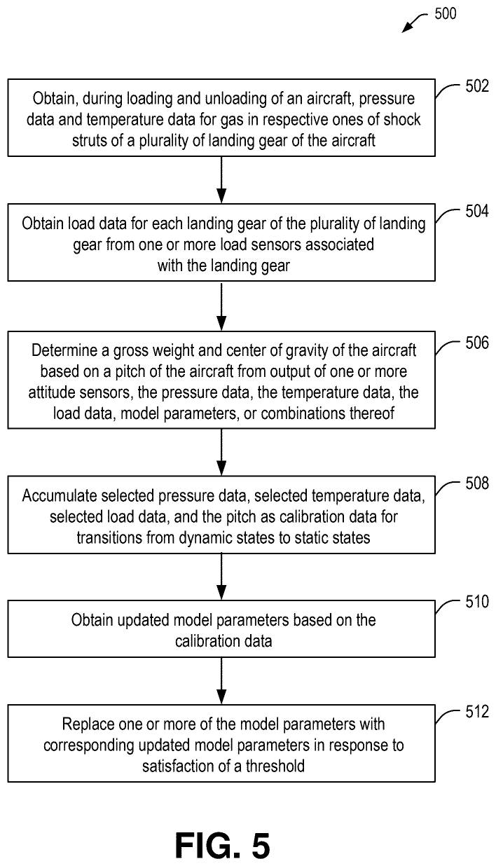

FIG. 5 depicts a flow chart of an implementation of a method 500 of use of an onboard weight and balance system 144. The method 500 may be performed by the computer system(s) 112 by execution of the weight and balance unit 148 and the self-calibration unit 150 of the onboard weight and balance system 144 by the processor(s) 136. The method 500, at block 502, includes obtaining, during loading and unloading of an aircraft, pressure data and temperature data for gas in respective ones of shock struts of a plurality of landing gear of the aircraft. The method 500, at block 504, includes obtaining, during the loading and the unloading of the aircraft, load data for each landing gear of the plurality of landing gear from one or more load sensors associated with the landing gear. For example, during loading and unloading of the aircraft 100, the computer system(s) 112 receive sensor output from the sensor system 114. The sensor output includes pressure data from the pressure sensors 156 corresponding to the gas pressure in the shock strut 116 of the landing gear 106 and the temperature data from the temperature sensors 158 corresponding to the gas temperature in the shock struts 116. The sensor data also includes load data for each landing gear of the plurality of landing gear 106 from one or more load sensors 146 associated with the landing gear 106.

The method 500, at block 506, includes determining a gross weight and CG of the aircraft based on a pitch of the aircraft from output of one or more attitude sensors, the pressure data, the temperature data, the load data, model parameters, or combinations thereof. For example, during the loading and unloading of the aircraft 100, the sensor output received by the computer system(s) 112 includes a pitch, a roll, or both, of the aircraft 100 as output from the attitude sensor(s) 160. The processor(s) 136 of the computer system(s) 112 executing the weight and balance unit 148 of the onboard weight and balance system 144 determine, for transitions of each shock strut 116 from dynamic states to static states, a vertical load on the shock strut 116 at the transition. For each shock strut 116, parameters for the shock strut 116 (e.g., rake angle, γ, and effective surface area of the end 130 of the inner cylinder 124 of the shock strut 116, A) and friction force parameters (e.g., m and b from the friction force parameters 152 based on the temperature of the gas in the shock strut 116 from the temperature data), and the pressure of the gas in the shock strut 116 at the transition from the pressure data, are used in equation (10) to determine the vertical force on the shock strut 116 for each transition of the shock strut 116 from a dynamic state to a static state.

At a second time during loading and unloading of the aircraft 100 from a nearest transition of a shock strut 116 from a dynamic state to a static state up to a time of the next transition to another static state or to an end of the loading/unloading of the aircraft 100, a delta load from the nearest transition to the second time is determined for each shock strut 116. The delta load is determined based on the load data of the load sensors 146 for a landing gear 106 associated with the shock strut 116 and gain values for the load sensors 146 retrieved from the load sensor gain data 154. The delta load for a particular load sensor 146 is the gain for the particular load sensor 146 multiplied by the difference of a load sensor output determined from the load data for the particular load sensor at the second time less a load sensor output determined from the load data for the particular load sensor 146 at the nearest transition. If the second time is the same time as the nearest transition, the delta load is zero. The delta load corresponds to the change in the vertical load on the shock strut 116 from the nearest transition to the second time. The vertical load on the shock strut 116 at the second time from the nearest transition to the next transition is determined, via equation (11), as the vertical load at the transition plus the delta load at the second time.

The weight and balance unit 148 determines the vertical load on each landing gear 106 at the second time as the vertical load on the shock strut 116 of the landing gear 106 at the second time plus the weight of components of the landing gear 106 unsupported by the gas in the shock strut 116. The weight and balance unit 148 retrieves the weight of components of the landing gear unsupported by the gas in the shock strut, M_{UN}, from the parameters of the aircraft 100 stored in the data 142 and determines the vertical weight on each of the landing gear 106 as the vertical weight on each of the landing gear 106 via equation (8). Based on the vertical weight on each of the landing gear 106, the weight and balance unit 148 determines the gross weight of the aircraft 100 via equation (3) at the second time. At the second time, the weight and balance unit 148 also determines the balance of the aircraft 100 using one or more of equations (4)-(7).

The method 500, at block 508, includes accumulating selected pressure data, selected temperature data, selected load data, and the pitch of the aircraft as calibration data for transitions of shock struts from dynamic states to static states. For example, for each transition to a static state of a shock strut 116 of a landing gear 106 detected by the weight and balance unit 148 during loading/unloading of the aircraft 100, the calibration data stores particular data associated with the transition in a data structure in the data 142 as part of an accumulation of calibration data. The calibration data for the transition includes the gas temperature of the shock strut 116 at the transition as the selected temperature data, the gas pressure of the shock strut 116 at the transition as the selected pressure data, and load sensor output of one or more load sensors 146 associated with the landing gear 106 as the selected load data. The calibration data associated with the transition also includes the pitch of the aircraft 100 at the transition, a pointer to calibration data associated with a nearest previous transition for a current cycle of the loading/unloading, an indicator that indicates whether the transition occurred during loading or unloading of the aircraft 100, an indicator based on pilot input, sensor input analysis, or both, that the transition occurred during fueling of the aircraft, other data, or combinations thereof. Analysis of the pressure data from the pressure sensors 156 by the weight and balance unit determines times corresponding to the transitions of the shock struts 116 from dynamic states to static states.

The method 500, at block 510, includes obtaining updated model parameters based on the calibration data. For example, the self-calibration unit 150 determines whether to use particular calibration data for a shock strut 116 to determine the parameters of slope and y-intercept of the parameters for friction force. In some implementations, the determination is based on the transition being associated with fueling of the aircraft 100 and the calibration data is not used to determine the slope and y-intercept for transitions that are not associated with fueling of the aircraft 100, or a weight is given to values of the slope and y-intercept by multiplying the values by a weighting factor. In other implementations, all calibration data is used to determine the slope. In some implementations, the slope is determined using equation (13) based on the delta load from a nearest previous transition for the shock strut 116 to the transition for the shock strut 116, the gas pressure in the shock strut at the transition less the gas pressure at the nearest previous transition, the pitch of the aircraft at the transition, and first parameters associated with the aircraft 100 (e.g., rake angle of the shock strut 116, effective surface area of the end 130 of the inner cylinder 124 from the data 142). The delta load is based on the gain for one or more of the load sensors 146 of the landing gear 106 associated with the shock strut 116 retrieved from the load sensor gain data 154, the load sensor output of the one or more load sensors 146 at the nearest previous transition, and the load sensor output of the one or more load sensors 146 at the transition. The y-intercept is determined using equation (15) based on the slope determined from equation (13), the gain for one or more of the load sensors 146 of the landing gear 106 associated with the shock strut 116 retrieved from the load sensor gain data 154, the load sensor output for the one or more of the load sensors 146, and the first parameters associated with the aircraft 100.

The slope and y-intercept determined from equation (13) and equation (15) are used to determine an updated slope and an updated y-intercept for a particular parameter set stored in the data 142. The particular parameter set corresponds to a first set of parameters associated with the gas temperature at the transition when the calibration data is associated with loading of the aircraft 100 and a second set of parameters associated with the gas temperature at the transition when the calibration data is associated with unloading the aircraft 100. A determination of whether the aircraft 100 is being loaded or unloaded is determined based on the indicator that indicates whether the transition occurred during loading or unloading of the aircraft 100 included in the calibration data. In some implementations, the calibration data does not include the indicator that indicates whether the transition occurred during loading or unloading of the aircraft 100, and the determination of whether the aircraft 100 is being loaded or unloaded is determined based in whether the delta load is a positive value, which corresponds to loading, or a negative value, which corresponds to unloading.

The updated slope is a running average of the slopes for a particular number of transitions. The particular number of transitions is adjustable when weighted values of the slope are used for particular slopes associated with fueling of the aircraft, defueling the aircraft, or both. Similarly, the updated y-intercept is a running average of the y-intercepts for a particular number of transitions, where the particular number of transitions is adjustable when weighted values of the slope are used for particular slopes associated with fueling of the aircraft, defueling the aircraft, or both. The updated slope and the updated y-intercept replace previous values of updated slope and y-intercept

As another example, the self-calibration unit 150 determines the gains, M, for the load sensors 146 associated with each of the landing gear 106 at each transition of a shock strut 116 associated with the landing gear 106 from a dynamic state to a static state using equation (22) based on the gas pressure in the shock strut 116 at the transition less the gas pressure in the shock strut 116 at the nearest previous transition and the load sensor output of each of the load sensors 146 at the transition less the corresponding load sensor output of the load sensor 146 at the nearest previous transition.

The gain for each load sensor 146 determined from equation (22) are used to determine an updated gain for the load sensor 146 as a running average for a particular number of transitions of the corresponding shock strut 116 from a dynamic state to a static state. The updated gain generated using the gain determined from equation (22) replaces the previous gain.

The method 500, at block 512, also includes replacing one or more of the model parameters with corresponding updated model parameters in response to satisfaction of a threshold. For example, all the slope and the y-intercept parameters, or the slope and y-intercept parameters where the number of values used to form the running average is above a particular threshold (e.g., 5, 10, or some other value), and the gain parameters are replaced after a passage of time of use of the aircraft 100 exceeds a time-of-use threshold, and a variable corresponding to a start of time of use is set to the current time. As another example, all the slope and y-intercept parameters associated with the friction force models for a particular shock strut 116, or the slope and y-intercept parameters for the shock strut 116 for sets where the number of values used to form the running average is above a particular threshold (e.g., 5, 10, or some other value), are replaced when a number of transitions threshold for the particular shock strut 116 is exceeded. A variable corresponding to the number of transitions, as well as the updated running averages for slope and y-intercept for the replaced parameters may be reset to zero.

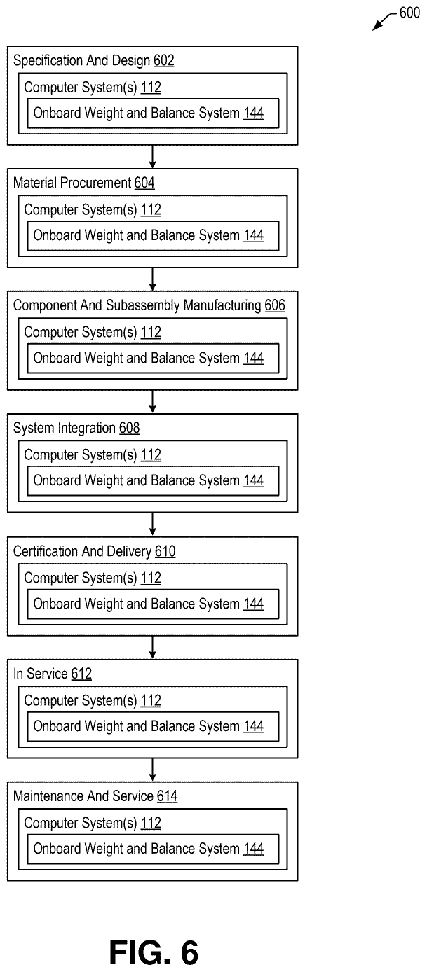

FIG. 6 is a flowchart illustrating a method 600 representing a life cycle of an aircraft 100 that includes the computer system(s) 112 with the onboard weight and balance system 144. During pre-production, the exemplary method 600 includes, at block 602, specification and design of the aircraft 100. During specification and design of the aircraft 100, the method 600 may include specification and design of the computer system(s) 112 and prediction of values of parameters associated with the aircraft 100 that are subsequently used by the computer system(s) 112. Such parameters include rakes angles of extended landing gear 106, effective surface area of each end 130 of the inner cylinders 124 that function as pistons of the shock struts 116, weight of each landing gear 106 unsupported by gas of the shock strut 116 associated with the landing gear, axial distances relative to a coordinate system from a reference point to effective ground contact locations of the landing gear 106 relative to a reference point, etc. Values of the parameters may be adjusted to correspond to actual values after production of the aircraft 100. At block 604, the method 600 includes material procurement, which may include procuring the computer system(s) 112 and other components of the aircraft 100.

During production, the method 600 includes, at block 606, component and subassembly manufacturing and, at block 608, system integration of the aircraft 100. Friction force parameters 152 for the friction models, initial load sensor gain data 154 for the load sensors 154, or both, are determined using a calibration procedure. The calibration procedure includes varying the load on the aircraft, at two or more different temperature conditions, when the aircraft is coupled to weight scales (e.g., each landing gear is positioned on a weight scale), and determining the friction force parameters 152 and gains and calibration data of the load sensor gain data 154 for the load sensors 146 based on experimental data obtained from the aircraft 100, and based on theoretical or empirical calculations based on the experimental data for parameters and calibration data not determined directly from the experimental data.

At block 610, the method 600 includes certification and delivery of the aircraft 100 and, at block 612, placing the aircraft 100 in service. Certification and delivery may include certification of the computer system 112 to place the aircraft 100 in service. At block 614, the method 600 includes performing maintenance and service on the aircraft 100, which may include modification, reconfiguration, refurbishment, replacement, and so on, of one or more systems of the aircraft 100. Service and maintenance of the computer system(s) 112 may include calibration of the onboard weight and balance system 144 to update all, or selected, parameters and gain data stored in the friction force parameters 152 and the load sensor gain data 154 based on output of calibrated weight scales that the landing gear 106 are positioned on.

Each of the processes of the method 600 may be performed or carried out by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

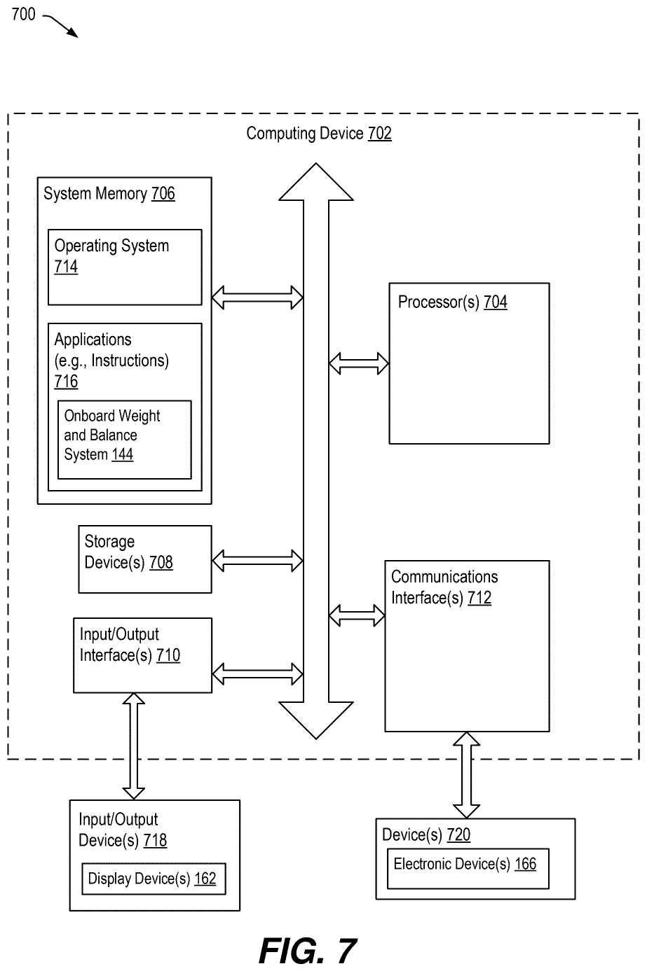

FIG. 7 is an illustration of a block diagram of a computing environment 700 including a computing device 702 configured to support implementations of computer-implemented methods and computer-executable program instructions (or code) according to the present disclosure. For example, the computing device 702, or portions thereof, may execute instructions to perform, or cause equipment to perform, operations described with reference to FIGS. 1-6. In implementations, computing devices 702 are, or are components of, the aircraft 100 and the computer system 112.

The computing device 702 includes one or more processors 704. The processor 704 communicates with a system memory 706, one or more storage devices 708, one or more input/output interfaces 710, one or more communications interfaces 712, or a combination thereof. The system memory 706 includes non-transitory computer readable media, including volatile memory devices (e.g., random access memory (RAM) devices), nonvolatile memory devices (e.g., read-only memory (ROM) devices, programmable read-only memory, and flash memory), or both. The system memory 706 includes an operating system 714, which may include a basic input/output system for booting the computing device 702 as well as a full operating system to enable the computing device 702 to interact with users, other programs, and other devices. The system memory 706 includes one or more applications 716 (e.g., instructions) which are executable by the processor 704. For example, when the computing device 702 is the computer system 112, the one or more applications 716 include the onboard weight and balance system 144.

In some configurations, the processor 704 communicates with the one or more storage devices 708. For example, the storage device 708 includes non-transitory computer readable media that can include nonvolatile storage devices, such as magnetic disks, optical disks, or flash memory devices. The storage devices 708 can include both removable and non-removable memory devices. The storage devices 708 can be configured to store an operating system, images of operating systems, applications, and program data. In particular implementations, the system memory 706, the storage device 708, or both, include tangible computer-readable media incorporated in hardware and which are not signals.

In some configurations, the processor 704 communicates with the one or more input/output interfaces 710 that enable the computing device 702 to communicate with one or more input/output devices 718 to facilitate user interaction. The input/output interfaces 710 can include serial interfaces (e.g., universal serial bus (USB) interfaces or Institute of Electrical and Electronics Engineers (IEEE) interfaces), parallel interfaces, display adapters, audio adapters, and other interfaces (“IEEE” is a registered trademark of The Institute of Electrical and Electronics Engineers, Inc. of Piscataway, New Jersey). The input/output devices 718 can include keyboards, pointing devices, displays (e.g., one or more monitors, one or more gauges, etc.), speakers, microphones, touch screens, rotatable selectors, levers, knobs, slides, switches, and other devices. The processor 704 detects interaction events based on user input received via the input/output interfaces 710. Additionally, the processor 704 sends a display to a display device via the input/output interfaces 710.

In some configurations, the processor 704 can communicate with one or more devices 720 via the one or more communications interfaces 712. The one or more devices 720 can include external computing devices contacted via a communication network and controllers, sensors, and other devices coupled to the computing device 702 via wired or wireless local connections. For example, when the computing device 702 part of the computer system(s) 112, the computing device 702 is configured to communicate via the interface 712 with devices external to the aircraft 100 such as an electronic device 166 associated with the loadmaster responsible for loading or unloading the aircraft 100. The one or more communications interfaces 712 may include wired Ethernet interfaces, IEEE 802 wireless interfaces, other wireless communication interfaces, one or more converters to convert analog signals to digital signals, electrical signals to optical signals, one or more converters to convert received optical signals to electrical signals, or other network interfaces.

In some implementations, a non-transitory, computer readable medium stores instructions that, when executed by one or more processors, cause the one or more processors to initiate, perform, or control operations to perform part or all of the functionality described above. For example, the instructions may be executable to implement one or more of the operations or methods described herein in association with FIGS. 1-7. In some implementations, part or all of one or more of the operations or methods described herein in association with FIGS. 1-7 may be implemented by one or more processors (e.g., one or more central processing units (CPUs), one or more graphics processing units (GPUs), one or more digital signal processors (DSPs), one or more application specific integrated circuits (ASICS), etc.) executing instructions, by dedicated hardware circuitry, or both.

Particular aspects of the disclosure are described below in sets of interrelated Examples:

According to Example 1, an aircraft includes a plurality of landing gear, wherein each landing gear of the plurality of landing gear includes a shock strut; one or more attitude sensors to output a pitch of the aircraft; a plurality of sensors associated with each landing gear, wherein the plurality of sensors includes a pressure sensor configured to generate pressure data indicative of a gas pressure in the shock strut, a temperature sensor configured to generate temperature data indicative of a gas temperature in the shock strut, and one or more load sensors to generate load data indicative of a load on the landing gear; and a computer system, wherein the computer system includes an onboard weight and balance system, and wherein the computer system is configured to determine a gross weight, a CG, or both, of the aircraft based on output of the one or more attitude sensors, output of the plurality of sensors, and model parameters; accumulate selected pressure data, selected temperature data, selected load data, and the pitch of the aircraft as calibration data for transitions of shock struts from dynamic states to static states; obtain one or more updated model parameters based on the calibration data; and replace one or more of the model parameters with corresponding updated model parameters in response to satisfaction of a threshold.

Example 2 includes the aircraft of Example 1, wherein a first portion of the calibration data is based on transitions that occur during fueling of the aircraft to enable determination of first parameters of the model parameters associated with loading the aircraft, and a second portion of the calibration data is based on transitions that occur during unloading of the aircraft to enable determination of second parameters of the model parameters associated with unloading the aircraft.

Example 3 includes the aircraft of Example 1 or Example 2, wherein the computer system is configured to determine for each landing gear from a first transition of the shock strut of the landing gear from a first dynamic state to a first static state up to a second transition of the shock strut from a second dynamic state that occurs after the first static state to a second static state, a vertical load of each landing gear on the ground, and wherein the vertical load on a particular landing gear at a particular time from the first transition up to the second transition is a sum of a vertical load on the shock strut of the particular landing gear at the first transition, a delta load indicated by the load data of the one or more load sensors associated with the particular landing gear from the first transition to the particular time, and weight of components of the landing gear not supported by the gas pressure in the shock strut.

Example 4 includes the aircraft of Example 3, wherein the vertical load on the shock strut at the first transition is determined based on a friction force determined via a friction force model, and wherein the friction force model determines the friction force for the shock strut at transitions from dynamic states to static states based on gas pressures in the shock strut at the transitions

Example 5 includes the aircraft of Example 3 or Example 4, wherein the delta load indicated by the load data of the one or more load sensor is determined based on gains for the one or more load sensors associated with the landing gear.

Example 6 includes the aircraft of any of Examples 1 to 5, wherein the computer system is further configured to determine a balance of the aircraft based on the gross weight, pitch attitude, and landing gear configuration of the aircraft.

Example 7 includes the aircraft of any of Examples 1 to 6, wherein the model parameters include friction force parameter sets associated with each shock strut, wherein the friction force parameter sets include first sets associated with loading the aircraft and second sets associated with unloading the aircraft, wherein a first set and a second set each include a slope and y-intercept of a linear equation associated with friction force at transitions from dynamic states to static states for the shock strut for a particular temperature range of gas temperature in the shock strut, and wherein, to determine the updated model parameters, the computer system is configured to obtain, based on the calibration data for a transition, first pressure and first load sensor output from the load data at a nearest previous transition of the shock strut, and second pressure and second load sensor output at the transition from the load data; determine a first slope and a first y-intercept associated with the transition based on a rake angle of the shock strut, the pitch, the first pressure, the second pressure, the first load sensor output, and the second load sensor output; determine a particular set associated with a particular temperature range including the gas temperature at the transition and based on whether the calibration data for the transition is associated with loading the aircraft or unloading the aircraft; and determine the updated parameters of the particular set as an updated slope and an updated y-intercept, wherein the updated slope and the updated y-intercept are based on previous calibration data at transitions associated with the particular set, and wherein the updated slope includes the first slope and the updated y-intercept includes the first y-intercept.

Example 8 includes the aircraft of Example 7, wherein the computer system includes load sensor data for each load sensor associated with the landing gear, wherein the load sensor data for a load sensor includes a parameter of gain for a gain model used to determine a delta load based on load sensor output of the load sensor based on the load data, and wherein to determine an updated parameter of gain for a particular load sensor of a particular landing gear associated with the shock strut at the transition, the computer system is configured to determine a first gain for the particular load sensor based on a first difference of a first vertical load on the shock strut at the transition and a second vertical load on the strut at the nearest previous transition and based on first load sensor output of the particular load sensor at the transition less second load sensor output of the particular load sensor at the previous transition, wherein the first difference is based on a first gas pressure in the shock strut at the transition less a second gas pressure in the shock strut at the nearest previous transition; and determine an updated parameter of the gain for the particular load sensor as a running average of values of the gain for the particular load sensor determined based on the calibration data for the shock strut for up to a particular number of transitions of the shock strut, wherein the updated parameter for the gain includes the first gain.

Example 9 includes the aircraft of Example 8, wherein the threshold for the parameter of gain for a first load sensor is satisfied when an error metric determined from the parameter of gain for the first load sensor and the updated parameter of gain for the load sensor is outside of a particular threshold range.

Example 10 includes the aircraft of any of Examples 1 to 9, wherein the computer system is configured to receive initial parameters based on a calibration procedure, and wherein initial parameters are determined based on input from weight scales coupled to the landing gear.

According to Example 11, a method includes obtaining, at a computer system of an aircraft during loading and unloading of the aircraft, pressure data and temperature data for gas in respective ones of shock struts of a plurality of landing gear of the aircraft; obtaining, at the computer system during the loading and the unloading of the aircraft, load data for each landing gear of the plurality of landing gear from one or more load sensors associated with the landing gear; determining, at the computer system, a gross weight, a CG, or both, of the aircraft based on a pitch of the aircraft from output of one or more attitude sensors, the pressure data, the temperature data, the load data, model parameters, or combinations thereof; accumulating, at the computer system, selected pressure data, selected temperature data, selected load data, and the pitch of the aircraft as calibration data for transitions of shock struts from dynamic states to static states; obtaining, at the computer system, updated model parameters based on the calibration data; and replacing, via the computer system, one or more of the model parameters with corresponding updated model parameters in response to satisfaction of a threshold.

Example 12 includes the method of Example 11, wherein a first portion of the calibration data is based on transitions that occur during fueling of the aircraft to enable determination of first parameters of the model parameters associated with loading the aircraft, and a second portion of the calibration data is based on transitions that occur during unloading of the aircraft to enable determination of second parameters of the model parameters associated with unloading the aircraft.

Example 13 includes the method of Example 11 or Example 12, wherein the computer system determines that the aircraft is being fueled or unloaded based on analysis of the pressure data for the shock struts, based on crew input, or both.

Example 14 includes the method of any of Examples 11 to 13, wherein the model parameters include friction force parameter sets associated with each shock strut, wherein the friction force parameter sets include first sets associated with loading the aircraft and second sets associated with unloading the aircraft, wherein a first set and a second set each include a slope and y-intercept of a linear equation associated with friction force at transitions from dynamic states to static states for the shock strut for a particular temperature range of gas temperature in the shock strut, and wherein, to determine the updated model parameters, and the method includes: obtaining, at the computer system based on the calibration data for a transition, first pressure and first load sensor output from the load data at a nearest previous transition of the shock strut, and second pressure and second load sensor output at the transition from the load data; determining, at the computer system, a first slope and a first y-intercept associated with the transition based on a rake angle of the shock strut, the pitch, the first pressure, the second pressure, the first load sensor output, and the second load sensor output; determining, at the computer system, a particular set associated with a particular temperature range including the gas temperature at the transition and based on whether the calibration data for the transition is associated with loading the aircraft or unloading the aircraft; and determining, at the computer system, the updated parameters of the particular set as an updated slope and an updated y-intercept, wherein the updated slope and the updated y-intercept are based on previous calibration data at transitions associated with the particular set, and wherein the updated slope includes the first slope and the updated y-intercept includes the first y-intercept.

Example 15 includes the method of Example 14, wherein the computer system includes load sensor data for each load sensor associated with the landing gear, wherein the load sensor data for a load sensor includes a parameter of gain for a gain model used to determine a delta load based on load sensor output of the load sensor based on the load data, and wherein to determine an updated parameter of gain for a particular load sensor of a particular landing gear associated with the shock strut at the transition, and the method comprises: determining, at the computer system, a first gain for the particular load sensor based on a first difference of a first vertical load on the shock strut at the transition and a second vertical load on the strut at the nearest previous transition and based on first load sensor output of the particular load sensor at the transition less second load sensor output of the particular load sensor at the previous transition, wherein the first difference is based on a first gas pressure in the shock strut at the transition less a second gas pressure in the shock strut at the nearest previous transition; and determining, at the computer system, an updated parameter of the gain for the particular load sensor as a running average of values of the gain for the particular load sensor determined based on the calibration data for the shock strut for up to a particular number of transitions of the shock strut, wherein the updated parameter for the gain includes the first gain.

Example 16 includes the method of any of Examples 11 to 15 and further includes determining a balance of the aircraft based on the gross weight, pitch attitude, and landing gear configuration of the aircraft.

According to Example 17, a non-transitory, computer-readable medium comprising instructions that, when executed by one or more processors associated with an onboard weight and balance system of an aircraft, cause the one or more processors to obtain, during loading and unloading of the aircraft, pressure data and temperature data for gas in respective ones of shock struts of a plurality of landing gear of the aircraft; obtain, during the loading and the unloading of the aircraft, load data for each landing gear of the plurality of landing gear from one or more load sensors associated with the landing gear; determine a gross weight, a CG, or both, of the aircraft based on a pitch of the aircraft from output of one or more attitude sensors, the pressure data, the temperature data, the load data, model parameters, or combinations thereof; accumulate selected pressure data, selected temperature data, selected load data, and the pitch of the aircraft as calibration data for transitions of shock struts from dynamic states to static states; obtain updated parameters for the model parameters based on the calibration data; and replace one or more of the model parameters with corresponding updated model parameters in response to satisfaction of a threshold.

Example 18 includes the non-transitory, computer-readable medium of Example 17, wherein a first portion of the calibration data is based on transitions that occur during fueling of the aircraft to enable determination of first parameters of the model parameters associated with loading the aircraft, and a second portion of the calibration data is based on transitions that occur during unloading of the aircraft to enable determination of second parameters of the model parameters associated with unloading the aircraft.

Example 19 includes the non-transitory, computer-readable medium of Example 17 or Example 18, wherein the model parameters associated with a shock strut of a particular landing gear of the plurality of landing gear include a slope and a y-intercept of a linear equation used to model friction force at transitions of the shock strut from a dynamic state to a static state.

Example 20 includes the non-transitory, computer-readable medium of any of Examples 17 to 19, wherein the instructions are executable by the one or more processors to determine a balance of the aircraft based on the gross weight, pitch attitude, and landing gear configuration of the aircraft.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

What is claimed is:

1. An aircraft comprising:
a plurality of landing gear, wherein each landing gear of the plurality of landing gear includes a shock strut;
one or more attitude sensors to output a pitch of the aircraft;
a plurality of sensors associated with each landing gear, wherein the plurality of sensors includes a pressure sensor configured to generate pressure data indicative of a gas pressure in the shock strut, a temperature sensor configured to generate temperature data indicative of a gas temperature in the shock strut, and one or more load sensors to generate load data indicative of a load on the landing gear; and
a computer system, wherein the computer system includes an onboard weight and balance system, and wherein the computer system is configured to:
determine a gross weight of the aircraft based on output of the one or more attitude sensors, output of the plurality of sensors, and model parameters;
accumulate selected pressure data, selected temperature data, selected load data, and the pitch of the aircraft as calibration data for transitions of shock struts from dynamic states to static states;
obtain one or more updated model parameters based on the calibration data; and
replace one or more of the model parameters with corresponding updated model parameters in response to satisfaction of a threshold.

2. The aircraft of claim 1, wherein a first portion of the calibration data is based on transitions that occur during fueling of the aircraft to enable determination of first parameters of the model parameters associated with loading the aircraft, and a second portion of the calibration data is based on transitions that occur during unloading of the aircraft to enable determination of second parameters of the model parameters associated with unloading the aircraft.

3. The aircraft of claim 1, wherein the computer system is configured to determine for each landing gear from a first transition of the shock strut of the landing gear from a first dynamic state to a first static state up to a second transition of the shock strut from a second dynamic state that occurs after the first static state to a second static state, a vertical load of each landing gear on ground, and wherein the vertical load on a particular landing gear at a particular time from the first transition up to the second transition is a sum of a vertical load on the shock strut of the particular landing gear at the first transition, a delta load indicated by the load data of the one or more load sensors associated with the particular landing gear from the first transition to the particular time, and weight of components of the landing gear not supported by the gas pressure in the shock strut.

4. The aircraft of claim 3, wherein the vertical load on the shock strut at the first transition is determined based on a friction force determined via a friction force model, and wherein the friction force model determines the friction force for the shock strut at transitions from dynamic states to static states based on gas pressures in the shock strut at the transitions.

5. The aircraft of claim 3, wherein the delta load indicated by the load data of the one or more load sensor is determined based on gains for the one or more load sensors associated with the landing gear.

6. The aircraft of claim 1, wherein the computer system is further configured to determine a balance of the aircraft based on the gross weight, pitch attitude, and landing gear configuration of the aircraft.

7. The aircraft of claim 1, wherein the model parameters include friction force parameter sets associated with each shock strut, wherein the friction force parameter sets include first sets associated with loading the aircraft and second sets associated with unloading the aircraft, wherein a first set and a second set each include a slope and y-intercept of a linear equation associated with friction force at transitions from dynamic states to static states for the shock strut for a particular temperature range of gas temperature in the shock strut, and wherein, to determine the updated model parameters, the computer system is configured to:
obtain, based on the calibration data for a transition, first pressure and first load sensor output from the load data at a nearest previous transition of the shock strut, and second pressure and second load sensor output at the transition from the load data;
determine a first slope and a first y-intercept associated with the transition based on a rake angle of the shock strut, the pitch, the first pressure, the second pressure, the first load sensor output, and the second load sensor output;
determine a particular set associated with a particular temperature range including the gas temperature at the transition and based on whether the calibration data for the transition is associated with loading the aircraft or unloading the aircraft; and
determine the updated model parameters of the particular set as an updated slope and an updated y-intercept, wherein the updated slope and the updated y-intercept are based on previous calibration data at transitions associated with the particular set, and wherein the updated slope includes the first slope and the updated y-intercept includes the first y-intercept.

8. The aircraft of claim 7, wherein the computer system includes load sensor data for each load sensor associated with the landing gear, wherein the load sensor data for a load sensor includes a parameter of gain for a gain model used to determine a delta load based on load sensor output of the load sensor based on the load data, and wherein to determine an updated parameter of gain for a particular load sensor of a particular landing gear associated with the shock strut at the transition, the computer system is configured to:
determine a first gain for the particular load sensor based on a first difference of a first vertical load on the shock strut at the transition and a second vertical load on the strut at the nearest previous transition and based on first load sensor output of the particular load sensor at the transition less second load sensor output of the particular load sensor at the previous transition, wherein the first difference is based on a first gas pressure in the shock strut at the transition less a second gas pressure in the shock strut at the nearest previous transition; and
determine an updated parameter of the gain for the particular load sensor as a running average of values of the gain for the particular load sensor determined based on the calibration data for the shock strut for up to a particular number of transitions of the shock strut, wherein the updated parameter for the gain includes the first gain.

9. The aircraft of claim 8, wherein the threshold for the parameter of gain for a first load sensor is satisfied when an error metric determined from the parameter of gain for the first load sensor and the updated parameter of gain for the load sensor is outside of a particular threshold range.

10. The aircraft of claim 1, wherein the computer system is configured to receive initial parameters based on a calibration procedure, and wherein initial parameters are determined based on input from weight scales coupled to the landing gear.

11. A method comprising:
obtaining, at a computer system of an aircraft during loading and unloading of the aircraft, pressure data and temperature data for gas in respective ones of shock struts of a plurality of landing gear of the aircraft;
obtaining, at the computer system during the loading and the unloading of the aircraft, load data for each landing gear of the plurality of landing gear from one or more load sensors associated with the landing gear;
determining, at the computer system, a gross weight of the aircraft based on a pitch of the aircraft from output of one or more attitude sensors, the pressure data, the temperature data, the load data, model parameters, or combinations thereof;
accumulating, at the computer system, selected pressure data, selected temperature data, selected load data, and the pitch of the aircraft as calibration data for transitions of shock struts from dynamic states to static states;
obtaining, at the computer system, updated model parameters based on the calibration data; and
replacing, via the computer system, one or more of the model parameters with corresponding updated model parameters in response to satisfaction of a threshold.

12. The method of claim 11, wherein a first portion of the calibration data is based on transitions that occur during fueling of the aircraft to enable determination of first parameters of the model parameters associated with loading the aircraft, and a second portion of the calibration data is based on transitions that occur during unloading of the aircraft to enable determination of second parameters of the model parameters associated with unloading the aircraft.

13. The method of claim 12, wherein the computer system determines that the aircraft is being fueled or unloaded based on analysis of the pressure data for the shock struts, based on crew input, or both.

14. The method of claim 11, wherein the model parameters include friction force parameter sets associated with each shock strut, wherein the friction force parameter sets include first sets associated with loading the aircraft and second sets associated with unloading the aircraft, wherein a first set and a second set each include a slope and y-intercept of a linear equation associated with friction force at transitions from dynamic states to static states for the shock strut for a particular temperature range of gas temperature in the shock strut, and wherein, to determine the updated model parameters, and the method includes:
obtaining, at the computer system based on the calibration data for a transition, first pressure and first load sensor output from the load data at a nearest previous transition of the shock strut, and second pressure and second load sensor output at the transition from the load data;
determining, at the computer system, a first slope and a first y-intercept associated with the transition based on a rake angle of the shock strut, the pitch, the first pressure, the second pressure, the first load sensor output, and the second load sensor output;
determining, at the computer system, a particular set associated with a particular temperature range including the gas temperature at the transition and based on whether the calibration data for the transition is associated with loading the aircraft or unloading the aircraft; and
determining, at the computer system, the updated model parameters of the particular set as an updated slope and an updated y-intercept, wherein the updated slope and the updated y-intercept are based on previous calibration data at transitions associated with the particular set, and wherein the updated slope includes the first slope and the updated y-intercept includes the first y-intercept.

15. The method of claim 14, wherein the computer system includes load sensor data for each load sensor associated with the landing gear, wherein the load sensor data for a load sensor includes a parameter of gain for a gain model used to determine a delta load based on load sensor output of the load sensor based on the load data, and wherein to determine an updated parameter of gain for a particular load sensor of a particular landing gear associated with the shock strut at the transition, and the method comprises:
determining, at the computer system, a first gain for the particular load sensor based on a first difference of a first vertical load on the shock strut at the transition and a second vertical load on the strut at the nearest previous transition and based on first load sensor output of the particular load sensor at the transition less second load sensor output of the particular load sensor at the previous transition, wherein the first difference is based on a first gas pressure in the shock strut at the transition less a second gas pressure in the shock strut at the nearest previous transition; and
determining, at the computer system, an updated parameter of the gain for the particular load sensor as a running average of values of the gain for the particular load sensor determined based on the calibration data for the shock strut for up to a particular number of transitions of the shock strut, wherein the updated parameter for the gain includes the first gain.

16. The method of claim 11, further comprising determining a balance of the aircraft based on the gross weight, pitch attitude, and landing gear configuration of the aircraft.

17. A non-transitory, computer-readable medium comprising instructions that, when executed by one or more processors associated with an onboard weight and balance system of an aircraft, cause the one or more processors to:
obtain, during loading and unloading of the aircraft, pressure data and temperature data for gas in respective ones of shock struts of a plurality of landing gear of the aircraft;
obtain, during the loading and the unloading of the aircraft, load data for each landing gear of the plurality of landing gear from one or more load sensors associated the landing gear;
determine a gross weight of the aircraft based on a pitch of the aircraft from output of one or more attitude sensors, the pressure data, the temperature data, the load data, model parameters, or combinations thereof;
accumulate selected pressure data, selected temperature data, selected load data, and the pitch of the aircraft as calibration data for transitions of shock struts from dynamic states to static states;
obtain updated parameters for the model parameters based on the calibration data; and
replace one or more of the model parameters with corresponding updated model parameters in response to satisfaction of a threshold.

18. The non-transitory, computer-readable medium of claim 17, wherein a first portion of the calibration data is based on transitions that occur during fueling of the aircraft to enable determination of first parameters of the model parameters associated with loading the aircraft, and a second portion of the calibration data is based on transitions that occur during unloading of the aircraft to enable determination of second parameters of the model parameters associated with unloading the aircraft.

19. The non-transitory, computer-readable medium of claim 17, wherein the model parameters associated with a shock strut of a particular landing gear of the plurality of landing gear include a slope and a y-intercept of a linear equation used to model friction force at transitions of the shock strut from a dynamic state to a static state.

20. The non-transitory, computer-readable medium of claim 17, wherein the instructions are executable by the one or more processors to determine a balance of the aircraft based on the gross weight, pitch attitude, and landing gear configuration of the aircraft.
